(19) United States
(12) Patent Application Publication
(10) Pub. No.: US 2025/0002276 A1
(43) Pub. Date: Jan. 2, 2025

(54) MEDIUM TRANSPORT APPARATUS, LIQUID EJECTION APPARATUS, AND MEDIUM TRANSPORT METHOD

(71) Applicant: SEIKO EPSON CORPORATION, Tokyo (JP)

(72) Inventor: Namiki HASHIGUCHI, Shiojiri-shi (JP)

(21) Appl. No.: 18/755,077

(22) Filed: Jun. 26, 2024

(30) Foreign Application Priority Data
Jun. 29, 2023 (JP) 2023-106808

(51) Int. Cl. B65H 1/04; B41J 11/00

(52) U.S. Cl. CPC B65H 1/04; B41J 11/007; B65H 2405/11; B65H 2801/06

(57) ABSTRACT

A medium transport apparatus includes a sheet feeding tray on which a medium is placed, a transport unit transporting the medium placed on the sheet feeding tray, a sheet ejection tray on which the medium transported by the transport unit is placed, a braking member braking the medium transported to the sheet ejection tray, a switching mechanism switching a position of the braking member, and an acquisition unit acquiring an index related to a state of the medium, wherein the switching mechanism sets the position of the braking member to a first position for braking the medium or a second position different from the first position based on the index acquired by the acquisition unit.

The present application is based on, and claims priority from JP Application Serial Number 2023-106808, filed Jun. 29, 2023, the disclosure of which is hereby incorporated by reference herein in its entirety.

### BACKGROUND

### 1. Technical Field

The present disclosure relates to a medium transport apparatus, a liquid ejection apparatus, and a medium transport method.

### 2. Related Art

An image reading apparatus provided with a sheet ejection stopper is known. An image reading apparatus disclosed in JP-A-2014-22840 includes a scanner unit and an automatic document transport unit. A document transported by the automatic document transport unit is ejected onto the sheet ejection tray. The sheet ejection stopper controls the leading end position of the document ejected onto the sheet ejection tray. The sheet ejection stopper is attached to a rotatable shaft. The shaft rotates in one direction or in the opposite direction by the rotational force of a motor. When the shaft rotates in one direction, the lower end portion of the sheet ejection stopper moves in a direction away from the sheet ejection tray. When the shaft rotates in the opposite direction, the lower end portion of the sheet ejection stopper moves in a direction toward the sheet ejection tray. The rotation direction of the shaft is switched according to the type and the amount of the mounted document. The support state of the sheet ejection stopper is changed according to the material and the amount of the mounted document, and thereby, the image reading apparatus suppresses a sheet ejection failure of the document.

JP-A-2014-22840 is an example of the related art.

The state of transport of a medium including a document by a transporter varies depending on the storage environment and the processing state of the medium, and a sheet ejection failure or the like may occur.

### SUMMARY

A medium transport apparatus according to an aspect of the present disclosure includes a sheet feeding tray on which a medium is placed, a transport unit transporting the medium placed on the sheet feeding tray, a sheet ejection tray on which the medium transported by the transport unit is placed, a braking member braking the medium transported to the sheet ejection tray, a switching mechanism switching a position of the braking member, and an acquisition unit acquiring an index related to a state of the medium, wherein the switching mechanism sets the position of the braking member to a first position for braking the medium or a second position different from the first position based on the index acquired by the acquisition unit.

A liquid ejection apparatus according to an aspect of the present disclosure includes a sheet feeding tray on which medium is placed, a transport unit transporting the medium placed on the sheet feeding tray, a liquid ejection unit ejecting a liquid onto the medium based on print data, a sheet ejection tray on which the medium with the liquid ejected thereon by the liquid ejection unit is placed, a braking member braking the medium transported to the sheet ejection tray, a switching mechanism switching a position of the braking member, and an acquisition unit acquiring an index related to a state of the medium, wherein the switching mechanism sets the position of the braking member to a first position for braking the medium or a second position different from the first position based on the index acquired by the acquisition unit.

A medium transport method according an aspect of the present disclosure includes acquiring an index related to a state of a medium, switching a position of a braking member braking the medium transported to a sheet ejection tray to a first position for braking the medium or a second position different from the first position based on the index, and transporting the medium to the sheet ejection tray.

### BRIEF DESCRIPTION OF THE DRAWINGS

FIG. 1 shows an external configuration of a multifunction peripheral.

FIG. 2 shows a schematic configuration of a scanner unit.

FIG. 3 shows the schematic configuration of the scanner unit.

FIG. 4 shows a block configuration of the scanner unit.

FIG. 5 shows an example of a determination table.

FIG. 6 shows a relationship between environmental information and environmental ranges.

FIG. 7 shows a control flow executed by the scanner unit.

FIG. 8 shows a schematic configuration of the scanner unit.

FIG. 9 shows the schematic configuration of the scanner unit.

FIG. 10 shows an example of a configuration of a document presser bar.

FIG. 11 shows a schematic configuration of a printer unit.

FIG. 12 shows the schematic configuration of the printer unit.

FIG. 13 shows a block configuration of the printer unit.

FIG. 14 shows a relationship between a print duty value and a medium presser bar position.

FIG. 15 shows a relationship between the print duty value and the medium presser bar position.

FIG. 16 shows a relationship between the print duty value and the medium presser bar position.

FIG. 17 shows a schematic configuration of the printer unit.

FIG. 18 shows a block configuration of the printer unit.

FIG. 19 shows an example of a state determination table.

### DESCRIPTION OF EMBODIMENTS

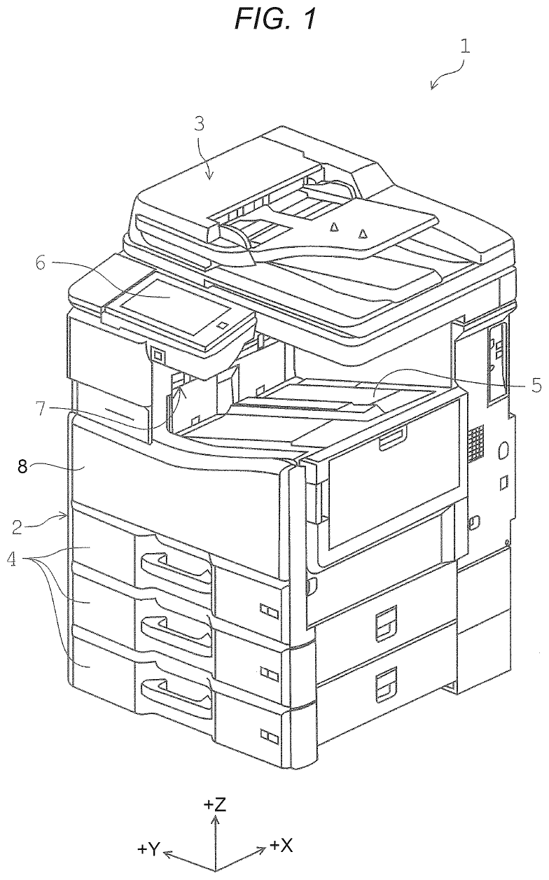

FIG. 1 shows an external configuration of a multifunction peripheral 1. FIG. 1 shows an appearance of the multifunction peripheral 1 in a perspective view. The multifunction peripheral 1 performs reading of a document M, printing on a print medium P, copying of the document M, and the like. The multifunction peripheral 1 includes a printer unit 2 and a scanner unit 3.

A plurality of drawings including FIG. 1 show an XYZ coordinate system. The X-axis is parallel to an installation surface of the multifunction peripheral 1. The X-axis is parallel to directions in which medium container cassettes 4 are inserted and detached. The +X direction is a direction in which the medium container cassettes 4 are inserted into the printer unit 2. The −X direction is a direction in which the medium container cassettes 4 are pulled out. The Y-axis is parallel to the installation surface and orthogonal to the X-axis. The +Y direction is a direction from right to left when the multifunction peripheral 1 is seen from the front. The front surface of the multifunction peripheral 1 is a surface on which the medium container cassettes 4 are operable. The −Y direction is a direction from left to right when the multifunction peripheral 1 is seen from the front. The Z-axis is perpendicular to the installation surface. The +Z direction is a direction upward from the installation surface. The −Z direction is a direction from above toward the installation surface.

The printer unit 2 is disposed on the installation surface. The printer unit 2 performs printing on the print medium P. The printer unit 2 includes a plurality of the medium container cassettes 4, a medium placement portion 5, an operation panel 6, an eject portion 7, and a front cover 8. The printer unit 2 corresponds to an example of a medium transport apparatus.

The medium container cassette 4 contains the print medium P placed therein. The medium container cassette 4 is disposed in a position in the −Z direction of the printer unit 2. Examples of the print medium P include plain paper, thick paper, and photographic paper. The print medium P corresponds to an example of a medium. The medium container cassette 4 is configured to be inserted into and detached from the printer unit 2. The printer unit 2 shown in FIG. 1 includes the plurality of medium container cassettes 4, but is not limited thereto. The medium container cassette 4 may be one. When the printer unit 2 includes a medium sheet feeding tray (not shown), the medium container cassette 4 may not be provided. The medium container cassette 4 and the medium sheet feeding tray correspond to examples of a sheet feeding tray.

The print medium P printed by a print head 110 of the printer unit 2 is placed on the medium placement portion 5. The print head 110 will be described later. The medium placement portion 5 is provided in a position in the +Z direction of the medium container cassette 4. The medium placement portion 5 corresponds to an example of a sheet ejection tray.

The operation panel 6 includes a display unit and an input unit. The display unit displays various kinds of information notified to a user. The input unit receives various input operations from the user. The operation panel 6 includes a display such as a liquid crystal panel. The operation panel 6 may include a plurality of operation buttons as the input units. When the display as the display unit has a touch input function, the operation panel 6 may not have the operation buttons. The multifunction peripheral 1 shown in FIG. 1 includes the operation panel 6 on the front surface of the printer unit 2, but is not limited thereto. The operation panel 6 may be provided in the scanner unit 3.

The eject portion 7 is an opening through which the print medium P printed by the print head 110 is ejected to the medium placement portion 5. The eject portion 7 is provided in a position in the +Z direction and the +Y direction of the medium placement portion 5. The print medium P ejected from the eject portion 7 is placed on the medium placement portion 5.

The front cover 8 is provided to be openable and closable with respect to the printer unit 2. When the front cover 8 is opened, the user can access the inside of the printer unit 2. As an example, the user can open the front cover 8 to remove paper jam of the print medium P occurring inside the printer unit 2.

The scanner unit 3 reads the document M. The document M corresponds to an example of the medium. The scanner unit 3 reads the document M and generates read data. The scanner unit 3 includes an ADF (Auto Document Feeder). The scanner unit 3 transmits read data to an external apparatus or the printer unit 2. The scanner unit 3 is disposed in a position in the +Z direction of the printer unit 2. The scanner unit 3 corresponds to an example of the medium transport apparatus.

### First Embodiment

A first embodiment shows the scanner unit 3 including a document presser bar 40. The scanner unit 3 forms a part of the multifunction peripheral 1, but is not limited thereto. The scanner unit 3 may be configured as a single unit.

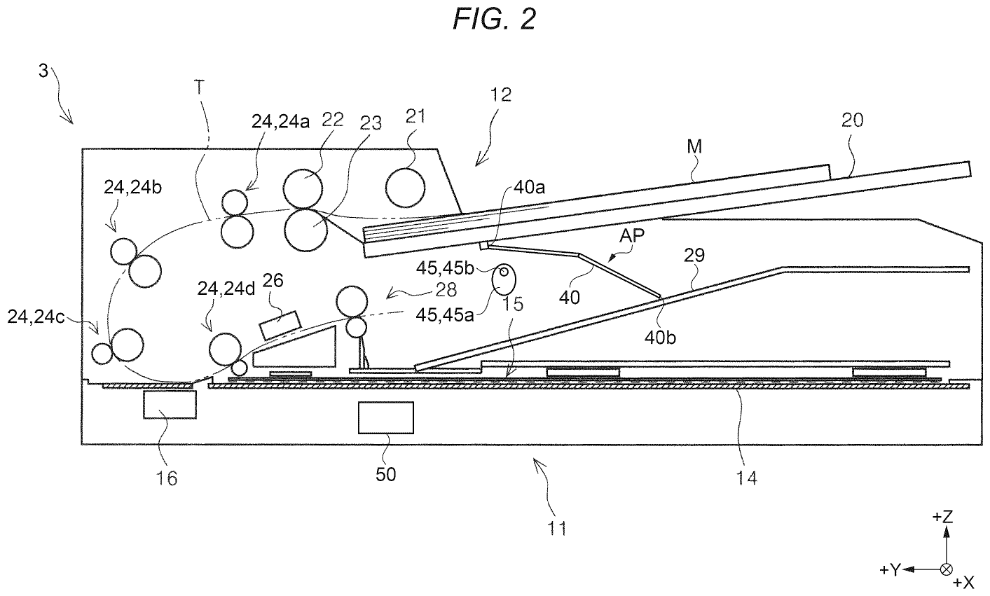

FIG. 2 shows a schematic configuration of the scanner unit 3. FIG. 2 shows a schematic configuration of a document transport path T of the scanner unit 3. The scanner unit 3 includes a scanner main body 11 and a document transport unit 12.

The scanner main body 11 reads the document M. The scanner main body 11 is disposed in a position in the −Z direction of the scanner unit 3. The scanner main body 11 includes a platen 14 and a first reading unit 16.

The platen 14 is configured such that the document M can be placed thereon. The user can place the document M on the platen 14 by pivoting the document transport unit 12 about a pivot shaft along the Y-axis. The pivot shaft is not shown. The platen 14 is formed using a light-transmissive member of glass or the like.

The first reading unit 16 reads a first surface of the document M. The first surface of the document M faces the first reading unit 16. The first reading unit 16 extends along the X-axis. The first reading unit 16 is disposed in a position in the −Z direction of the platen 14. The first reading unit 16 reads the document M transported by the document transport unit 12. The first reading unit 16 moves along the Y-axis by being driven by a reading unit drive mechanism (not shown). The first reading unit 16 reads the document M placed on the platen 14 by moving along the Y-axis. The first reading unit 16 includes, for example, an optical sensor such as a CIS (Contact Image Sensor) and a CCD (Charge Coupled Device).

The document transport unit 12 transports the document M to be read by the first reading unit 16. The document transport unit 12 transports the document M along the document transport path T. The document transport unit 12 transports the document M from a document feeding tray 20 toward a document ejection tray 29. The document transport unit 12 includes a document mat 15, the document feeding tray 20, a document pickup roller 21, a document feeding roller 22, a document separating roller 23, a plurality of document transport roller pairs 24, a second reading unit 26, a document ejection roller pair 28, the document ejection tray 29, the document presser bar 40, and a document presser bar drive mechanism 45.

The document mat 15 contacts the platen 14. When the user places the document M on the platen 14, the document mat 15 presses the document M toward the platen 14. The document mat 15 is attached to a surface in the −Z direction of the document transport unit 12.

On the document feeding tray 20, the document M to be transported to the document transport path T is placed. The document feeding tray 20 is provided on an upper surface of the scanner unit 3. The document feeding tray 20 may include an edge guide (not shown). The edge guide guides a side edge of the document M. The document feeding tray 20 corresponds to an example of a sheet feeding tray.

The document pickup roller 21 picks up the document M placed on the document feeding tray 20. The document pickup roller 21 is configured to be movable between a separation position where the roller is separated from the document M placed on the document feeding tray 20 and a contact position where the roller contacts the document M. The document pickup roller 21 picks up the document M in the contact position and feeds the document M to the document feeding roller 22.

The document feeding roller 22 feeds the document M fed to the document transport path T by the document pickup roller 21. The document feeding roller 22 feeds the document M by a driving force transmitted from a document transport mechanism 60, which will be described later.

When a plurality of documents M are fed from the document pickup roller 21, the document separating roller 23 separates the plurality of documents M in one sheet. The document separating roller 23 contacts the document feeding roller 22 via the document M to form a nip. The document M is separated at the nip between the document feeding roller 22 and the document separating roller 23.

The plurality of document transport roller pairs 24 transport the document M along the document transport path T. The document transport path T shown in FIG. 2 is a curved inversion path. The plurality of document transport roller pairs 24 transport the document M along the curved inversion path. The orientation of the document M transported along the curved inversion path is inverted. The plurality of document transport roller pairs 24 include a first document transport roller pair 24a, a second document transport roller pair 24b, a third document transport roller pair 24c, and a fourth document transport roller pair 24d. The document transport unit 12 shown in FIG. 2 includes the four document transport roller pairs 24, but is not limited thereto. The number of document transport roller pairs 24 is appropriately set.

The first document transport roller pair 24a supports the document M fed by the document feeding roller 22. The first document transport roller pair 24a transports the document M toward the second document transport roller pair 24b.

The second document transport roller pair 24b supports the document M transported by the first document transport roller pair 24a. The second document transport roller pair 24b transports the document M toward the third document transport roller pair 24c.

The third document transport roller pair 24c supports the document M transported by the second document transport roller pair 24b. The third document transport roller pair 24c transports the document M toward the fourth document transport roller pair 24d.

The fourth document transport roller pair 24d supports the document M transported by the third document transport roller pair 24c. The fourth document transport roller pair 24d transports the document M toward the document ejection roller pair 28.

In the document transport path T between the third document transport roller pair 24c and the fourth document transport roller pair 24d, the first surface of the document M faces the first reading unit 16. The first surface of the document M is read by the first reading unit 16 in a position facing the first reading unit 16.

A driving force is transmitted from the document transport mechanism 60 to at least one of the plurality of document transport roller pairs 24. One of the two rollers constituting the document transport roller pair 24 is rotated by the transmitted driving force. As the rollers rotate, the document transport roller pair 24 transports the document M.

The second reading unit 26 is disposed along the document transport path T between the fourth document transport roller pair 24d and the document ejection roller pair 28. The second reading unit 26 is disposed in a position facing a second surface of the document M. The second surface of the document M is opposite to the first surface. The second reading unit 26 can read the second surface of the document M. The second reading unit 26 includes an optical sensor such as a CIS or a CCD.

The document ejection roller pair 28 ejects the document M transported from the fourth document transport roller pair 24d to the document ejection tray 29. The document ejection roller pair 28 is disposed in a position in the +Z direction of an end portion in the +Y direction of the document ejection tray 29.

The document M transported by the document transport roller pairs 24, the document ejection roller pair 28, and the like is placed on the document ejection tray 29. The document ejection tray 29 is disposed in a position in the −Z direction of the document feeding tray 20. The document ejection tray 29 corresponds to an example of the sheet ejection tray.

The document presser bar 40 brakes the document M transported to the document ejection tray 29. The document presser bar 40 contacts the document M transported to the document ejection tray 29. The document presser bar 40 attenuates the transport speed of the document M by contacting the document M. The transport speed of the document M varies depending on the type, state, and the like of the document. When the transport speed of the document M varies, the placement position of the document M on the document ejection tray 29 varies. The document presser bar 40 can reduce variations in the placement positions of the documents M placed on the document ejection tray 29 by decelerating the documents M.

The document presser bar 40 is formed using a metal material, a resin material, or the like. The document presser bar 40 is preferably formed using an elastic material. The document presser bar 40 shown in FIG. 2 has a bent portion, but is not limited thereto. The document presser bar 40 may be formed of a flat plate member, a curved member, or the like. The configuration of the document presser bar 40 is not limited as long as the bar can brake the document M transported to the document ejection tray 29. The document presser bar 40 corresponds to an example of a braking member. The document presser bar 40 includes a support end portion 40a and an actuation end portion 40b.

The support end portion 40a is supported by the document feeding tray 20. The support end portion 40a may be supported by the document feeding tray 20 so that the document presser bar 40 can be displaced. The support end portion 40a is supported on a surface of the document feeding tray 20 in the −Z direction or a side surface of the document transport unit 12 in the +X direction or the −X direction.

The actuation end portion 40b contacts the document M on the document ejection tray 29. The actuation end portion 40b is a displaceable free end. The actuation end portion 40b may be rounded. The actuation end portion 40b may be provided with a member that applies a load to the document M or the like.

The document presser bar drive mechanism 45 switches the position of the document presser bar 40. The document presser bar drive mechanism 45 corresponds to an example of a switching mechanism. The document presser bar drive mechanism 45 includes a document presser bar drive cam 45a, a document presser bar drive cam shaft 45b, and a cam drive motor 45c. The cam drive motor 45c will be described later.

The document presser bar drive cam 45a rotates to change the position of contact with the document presser bar 40. The document presser bar drive cam 45a may rotate to be separated from the document presser bar 40. The document presser bar drive cam 45a rotates, and thereby, the document presser bar 40 is displaced to an actuation position AP or an evacuation position EP. The document presser bar drive cam 45a is driven under control of a document presser bar control unit 75 described later. The document presser bar drive cam 45a corresponds to an example of a cam.

The document presser bar drive cam shaft 45b rotatably supports the document presser bar drive cam 45a. The document presser bar drive cam shaft 45b is supported on a side surface of the document transport unit 12 or a surface of the document feeding tray 20 in the −Z direction. The document presser bar drive cam 45a rotates about the document presser bar drive cam shaft 45b.

FIG. 2 shows the document presser bar 40 in the actuation position AP. When the document presser bar 40 is in the actuation position AP, the actuation end portion 40b of the document presser bar 40 is located in a position where the portion can contact the document M on the document ejection tray 29. The document presser bar 40 can brake the document M in the actuation position AP. The actuation position AP is a position for braking the document M. The actuation position AP corresponds to an example of a first position.

The document presser bar drive cam 45a shown in FIG. 2 is separated from the document presser bar 40 when the document presser bar 40 is in the actuation position AP. The document presser bar 40 is brought into the actuation position AP by its own weight. In FIG. 2, the document presser bar 40 is in the actuation position AP by the document presser bar drive cam 45a being separated from the document presser bar 40, but not limited thereto. The document presser bar drive cam 45a may bring the document presser bar 40 into the actuation position AP by adjusting the position of contact with the document presser bar 40.

The scanner unit 3 includes a temperature and humidity sensor 50. The temperature and humidity sensor 50 acquires environmental information of the document M placed on the multifunction peripheral 1. The temperature and humidity sensor 50 measures at least one of the ambient temperature and the ambient humidity of the multifunction peripheral 1 as the environmental information. The ambient temperature and the ambient humidity are examples of state data relating to the state of the document M placed on the document feeding tray 20. The state data corresponds to an example of an index. The environmental information including the ambient temperature and the ambient humidity corresponds to an example of a placement environment. The scanner unit 3 shown in FIG. 2 includes the temperature and humidity sensor 50 in the scanner main body 11, but is not limited thereto. The temperature and humidity sensor 50 may be provided in the document transport unit 12 or the printer unit 2. The temperature and humidity sensor 50 corresponds to an example of an acquisition unit.

The scanner unit 3 may include a temperature sensor or a humidity sensor instead of the temperature and humidity sensor 50. The temperature sensor measures the ambient temperature of the multifunction peripheral 1. The humidity sensor measures ambient humidity of the multifunction peripheral 1.

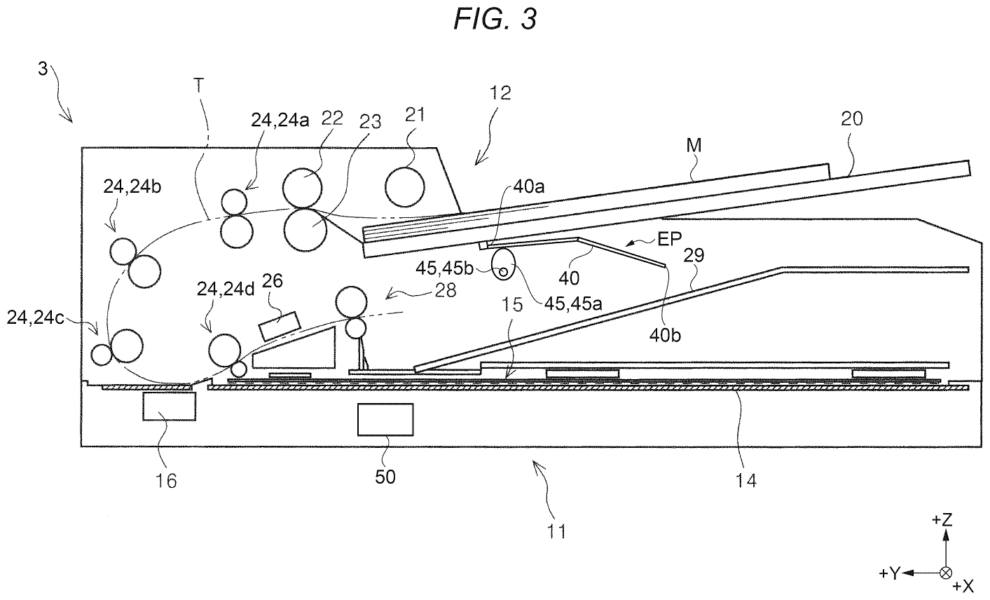

FIG. 3 shows a schematic configuration of the scanner unit 3. FIG. 3 shows the document presser bar 40 in the evacuation position EP. FIG. 3 is the same as the configuration of the scanner unit 3 shown in FIG. 2 except for the position of the document presser bar 40.

FIG. 3 shows the document presser bar 40 in the evacuation position EP. When the document presser bar 40 is in the evacuation position EP, as shown in FIG. 3, the actuation end portion 40b of the document presser bar 40 is located in a position where the portion does not contact the document M on the document ejection tray 29. The document presser bar 40 does not brake the document M in the evacuation position EP. The evacuation position EP is, for example, a position in which the document M is not braked. When the document presser bar 40 is in the evacuation position EP, the actuation end portion 40b of the document presser bar 40 may be located in a position where the portion contacts the document M curled in a predetermined amount or more. When the document presser bar 40 is in the evacuation position EP, the bar contacts the document M curled in the predetermined amount or more. The document presser bar 40 functions as a member suppressing curling of the document M. The evacuation position EP is a position different from the actuation position AP. The evacuation position EP corresponds to an example of a second position.

The document presser bar drive cam 45a shown in FIG. 3 contacts the document presser bar 40 when the document presser bar 40 is in the evacuation position EP. The document presser bar drive cam 45a rotates to push up the document presser bar 40. The document presser bar 40 pivots about the support end portion 40a by the document presser bar drive cam 45a and is displaced into the evacuation position EP. The rotation angle and the like of the document presser bar drive cam 45a are appropriately set.

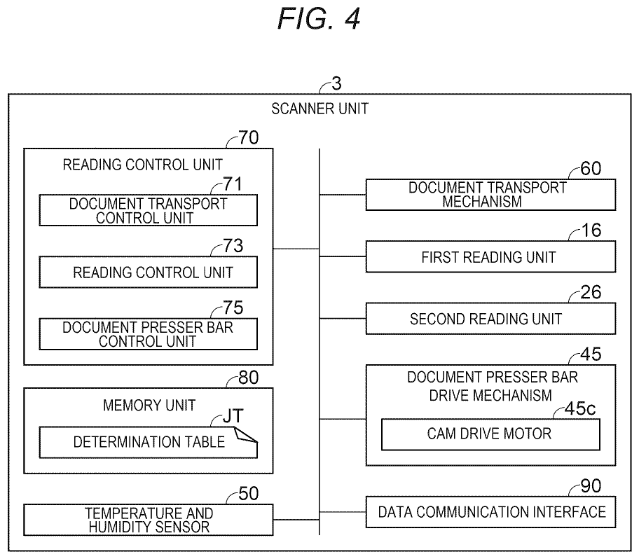

FIG. 4 shows a block configuration of the scanner unit 3. The scanner unit 3 includes the first reading unit 16, the second reading unit 26, the document presser bar drive mechanism 45, the temperature and humidity sensor 50, the document transport mechanism 60, a reading control unit 70, a memory unit 80, and a data communication interface 90.

The first reading unit 16 reads the document M and generates read data. As an example, the first reading unit 16 reads the first surface of the document M transported within the document transport unit 12 and generates first surface read data. The first surface read data is an example of read data. The first reading unit 16 transmits the generated read data to the data communication interface 90 or the like.

The second reading unit 26 reads the document M and generates read data. The second reading unit 26 reads the second surface of the document M transported within the document transport unit 12 and generates second surface read data. The second surface read data is an example of the read data. The second reading unit 26 transmits the generated read data to the data communication interface 90 or the like.

The document presser bar drive mechanism 45 drives the document presser bar 40. The document presser bar drive mechanism 45 includes the cam drive motor 45c and a transmission mechanism (not shown) in addition to the document presser bar drive cam 45a. The cam drive motor 45c generates a driving force. The transmission mechanism transmits the driving force to the document presser bar drive cam 45a. The document presser bar drive cam 45a is rotated by the transmitted driving force. The cam drive motor 45c corresponds to an example of a drive source.

The temperature and humidity sensor 50 transmits at least one of the measured ambient temperature and ambient humidity to the reading control unit 70 or the like. The temperature and humidity sensor 50 may transmit at least one of the measured ambient temperature and ambient humidity to the printer unit 2 via the data communication interface 90.

The document transport mechanism 60 drives the document pickup roller 21, the document feeding roller 22, the document separating roller 23, the plurality of document transport roller pairs 24, and the document ejection roller pair 28. The document transport mechanism 60 includes a drive source that generates a driving force. The document transport mechanism 60 transmits a driving force generated by the drive source to the document transport roller pairs 24 and the like. The document transport mechanism 60 drives the document transport roller pairs 24 and the like by transmitting the driving force. The document transport mechanism 60 transports the document M placed on the document feeding tray 20 toward the document ejection tray 29 by driving the document transport roller pairs 24 and the like. The document transport mechanism 60 corresponds to an example of a transport unit.

The reading control unit 70 is a controller circuit that controls the scanner unit 3. The reading control unit 70 is, for example, a processor including a CPU (Central Processing Unit). The reading control unit 70 includes one or more processors. The reading control unit 70 operates as a functional unit by executing a reading control program. The reading control unit 70 functions as a document transport control unit 71, a reading control unit 73, and a document presser bar control unit 75. The reading control unit 70 may function as a functional unit other than the document transport control unit 71, the reading control unit 73, and the document presser bar control unit 75.

The document transport control unit 71 controls transport of the document M. The document transport control unit 71 controls the document transport mechanism 60 to transport the document M along the document transport path T. The document transport control unit 71 controls a timing to start transport of the document M, a transport speed of the document M, and the like.

The reading control unit 73 controls reading of the document M by the first reading unit 16 and the second reading unit 26. The reading control unit 73 controls the first reading unit 16 to generate the first surface read data as read data. The reading control unit 73 controls the second reading unit 26 to generate the second surface read data as read data. The reading control unit 73 controls the reading timing, the reading resolution, and the like of the first reading unit 16 and the second reading unit 26.

The document presser bar control unit 75 controls the position of the document presser bar 40. The document presser bar control unit 75 controls the document presser bar drive mechanism 45 to drive the document presser bar drive cam 45a. The document presser bar control unit 75 drives the document presser bar drive cam 45a to displace the document presser bar 40 into the actuation position AP or the evacuation position EP.

The document presser bar control unit 75 acquires the environmental information including the ambient temperature and the ambient humidity from the temperature and humidity sensor 50. The document presser bar control unit 75 determines to set the position of the document presser bar 40 to the actuation position AP or the evacuation position EP based on the acquired environmental information. The document presser bar drive mechanism 45 displaces the document presser bar 40 into the determined position under the control of the document presser bar control unit 75. The document presser bar drive mechanism 45 sets the document presser bar 40 into the actuation position AP or the evacuation position EP.

As an example, the document presser bar control unit 75 uses a determination table JT to determine whether the position of the document presser bar 40 is set to the actuation position AP or the evacuation position EP. The document presser bar control unit 75 reads the determination table JT from the memory unit 80. The document presser bar control unit 75 compares the environmental information with the determination table JT to determine the position of the document presser bar 40.

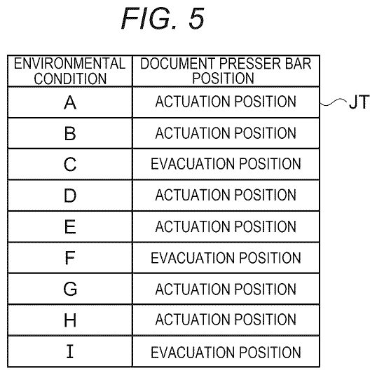

FIG. 5 shows an example of the determination table JT. The determination table JT shown in FIG. 5 shows a correspondence relationship between an environmental condition and the document presser bar position. The document presser bar position indicates the position of the document presser bar 40. The environmental condition is divisionally shown in respective environmental ranges of a range A, a range B, a range C, a range D, a range E, a range F, a range G, a range H, and a range I.

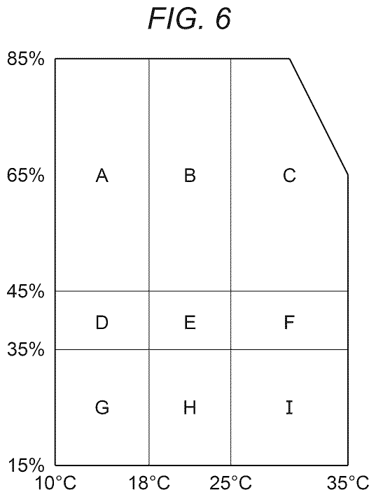

FIG. 6 shows a relationship between the FIG. environmental information and the environmental ranges. FIG. 6 shows a case where the environmental condition is divided according to temperature and humidity. FIG. 6 shows the range A, the range B, the range C, the range D, the range E, the range F, the range G, the range H, and the range I divided according to temperature and humidity. The temperature ranges from 10° C. to 35° C. The humidity ranges from 15% to 85%. The temperature ranges and the humidity ranges shown in FIG. 6 are based on the specifications of the use environments of the multifunction peripheral 1. For example, in the range A, the temperature is 10° C. or higher and lower than 18° C., and the humidity is from 45% to 85%. The range B, the range C, the range D, the range E, the range F, the range G, the range H, and the range I are set according to the temperature and the humidity similarly to the range A. Each environmental range shown in FIG. 5 is set according to the temperature and humidity shown in FIG. 6.

As shown in FIG. 5, according to the determination table JT, the environmental condition and the document presser bar position is correlated. When the environmental condition is any one of the range A, the range B, the range D, the range E, the range G, and the range H, the document presser bar position is set to the actuation position AP. When the environmental condition is the range C, the range F, or the range I, the document presser bar position is set to the evacuation position EP.

When the environmental condition is, for example, the range C in which the temperature is from 25° C. to 35° C. and the humidity is from 45% to 85%, the moisture content of the document M placed on the document feeding tray 20 increases. When the moisture content of the document M increases, the stiffness of the document M formed of paper decreases. When the stiffness of the document M decreases, wrinkles or the like may be produced in the document M due to contact with the document presser bar 40. When the environmental condition is the range C, the document presser bar control unit 75 controls the document presser bar 40 to be in the evacuation position EP. When the document presser bar 40 is in the evacuation position EP, the document presser bar 40 and the document M do not contact each other. The wrinkles or the like produced in the document M due to the contact between the document presser bar 40 and the document M can be prevented.

When the environmental condition is, for example, the range D in which the temperature is 10° C. or higher and lower than 18° C. and the humidity is 35% or higher and lower than 45%, the moisture content of the document M placed on the document feeding tray 20 is low. When the moisture content of the document M is low, the stiffness of the document M formed of paper is maintained. When the stiffness of the document M is maintained, wrinkles or the like due to contact with the document presser bar 40 are less likely to be produced in the document M. When the environmental condition is the range D, the document presser bar control unit 75 performs control to set the document presser bar 40 into the actuation position AP. When the document presser bar 40 is in the actuation position AP, the document presser bar 40 and the document M contact each other. The document presser bar 40 can brake the transported document M by coming into contact with the document M.

The determination table JT shown in FIG. 5 shows the relationship between the environmental information including the temperature and the humidity and the document presser bar position, but is not limited thereto. The determination table JT may indicate a correspondence relationship between the humidity and the document presser bar position as an example. In this case, the temperature and humidity sensor 50 measures the ambient humidity. The document presser bar control unit 75 determines the position of the document presser bar 40 using the ambient humidity and the determination table JT indicating the correspondence relationship between the humidity and the document presser bar position.

The memory unit 80 shown in FIG. 4 stores various types of information. The memory unit 80 stores the reading control program executed by the reading control unit 70. The memory unit 80 stores the determination table JT. The memory unit 80 may store the read data and the like. The memory unit 80 includes a semiconductor memory such as a ROM (Read Only Memory) and a RAM (Random Access Memory).

The data communication interface 90 is an interface circuit for communication connection to the printer unit 2. The data communication interface 90 communicates with the printer unit 2 according to a predetermined communication protocol. The data communication interface 90 includes a wired connector such as a USB (Universal Serial Bus) connector. The data communication interface 90 may be communicably connected to an external apparatus. The data communication interface 90 has various ports such as a Wi-Fi communication port and a Bluetooth communication port, and is communicably connected to an external apparatus. The data communication interface 90 transmits the read data to the printer unit 2 or the like. The data communication interface 90 receives input data input to the operation panel 6 or the like. Here, Wi-Fi and Bluetooth are registered trademarks.

The scanner unit 3 includes the document feeding tray 20 on which the document M is placed, the document transport mechanism 60 that transports the document M placed on the document feeding tray 20, the document ejection tray 29 on which the document M transported by the document transport mechanism 60 is placed, the document presser bar 40 that brakes the document M transported to the document ejection tray 29, the document presser bar drive mechanism 45 that switches the position of the document presser bar 40, and the temperature and humidity sensor 50 that acquires the state data related to the state of the document M. The document presser bar drive mechanism 45 sets the position of the document presser bar 40 to the actuation position AP for braking the document M or the evacuation position EP different from the actuation position AP based on the state data acquired by the temperature and humidity sensor 50.

The position of the document presser bar 40 is changed based on the ambient temperature and the ambient humidity, and thereby, the scanner unit 3 can reduce a transport failure such as breakage of the document M by the document presser bar 40.

The temperature and humidity sensor 50 preferably acquires the environmental information of the document M as the state data.

The temperature and humidity sensor 50 acquires environmental information including the ambient temperature and the ambient humidity, and thereby, the scanner unit 3 can adjust the position of the document presser bar 40 based on the state of the document M.

The document presser bar drive mechanism 45 preferably has the cam drive motor 45c and the document presser bar drive cam 45a that rotates by the driving force of the cam drive motor 45c.

The cam drive motor 45c and the document presser bar drive cam 45a are used, and thereby, the scanner unit 3 can easily switch the position of the document presser bar 40.

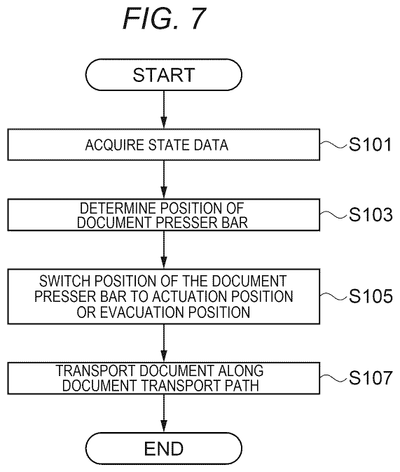

FIG. 7 shows a control flow executed by the scanner unit 3. FIG. 7 shows the control flow in a flowchart. The control flow shown in FIG. 7 is performed in the scanner unit 3 by the reading control unit 70 executing the reading control program. The control flow corresponds to an example of a medium transport method.

At step S101, the reading control unit 70 acquires the state data. The document presser bar control unit 75 of the reading control unit 70 acquires the state data from the temperature and humidity sensor 50. The temperature and humidity sensor 50 measures the environmental information including at least one of the ambient temperature and the ambient humidity. The temperature and humidity sensor 50 transmits the environmental information to the document presser bar control unit 75. The document presser bar control unit 75 receives the environmental information. The document presser bar control unit 75 acquires the environmental information as the state data. The temperature and humidity sensor 50 may measure temporal change data of the ambient temperature and the ambient humidity as the environmental information, and transmit the environmental information to the document presser bar control unit 75.

After acquiring the state data, at step S103, the reading control unit 70 determines the position of the document presser bar 40. The document presser bar control unit 75 reads out the determination table JT from the memory unit 80 as an example. The document presser bar control unit 75 determines the position of the document presser bar 40 using the environmental information including the ambient temperature and the ambient humidity and the determination table JT. The document presser bar control unit 75 determines the position of the document presser bar 40 to be the actuation position AP or the evacuation position EP.

After determining the position of the document presser bar 40, at step S105, the reading control unit 70 switches the position of the document presser bar 40 to the actuation position AP or the evacuation position EP. The document presser bar control unit 75 controls the document presser bar drive mechanism 45 to switch the position of the document presser bar 40 to the determined position. The document presser bar control unit 75 controls the document presser bar drive mechanism 45 to switch the position of the document presser bar 40 to the actuation position AP or the evacuation position EP. The document presser bar drive mechanism 45 switches the position of the document presser bar 40 to the actuation position AP or the evacuation position EP.

After the position of the document presser bar 40 is switched, at step S107, the reading control unit 70 transports the document M along the document transport path T. The document transport control unit 71 controls the document transport mechanism 60 to transport the document M in the document transport path T. The document transport mechanism 60 transports the document M to the document ejection tray 29. The transported document M is placed on the document ejection tray 29. In the actuation position AP, the document presser bar 40 contacts the document M transported to the document ejection tray 29 and brakes the document M. In the evacuation position EP, the document presser bar 40 does not contact the document M transported to the document ejection tray 29, and does not brake the document M.

The control flow acquires the state data related to the state of the document M, switches the position of the document presser bar 40 for braking the document M that is transported to the document ejection tray 29 based on the state data to the actuation position AP for braking the document M or the evacuation position EP different from the actuation position AP, and transports the document M to the document ejection tray 29.

The position of the document presser bar 40 is changed based on the ambient temperature and the ambient humidity, and thereby, the scanner unit 3 can reduce a transport failure such as breakage of the document M by the document presser bar 40.

### Second Embodiment

A second embodiment shows the scanner unit 3 including the document presser bar 40. The scanner unit 3 shown in the second embodiment includes a drive mechanism of the document presser bar 40 different from the document presser bar drive mechanism 45 of the scanner unit 3 shown in the first embodiment. The scanner unit 3 forms a part of the multifunction peripheral 1, but is not limited thereto. The scanner unit 3 may be configured as a single unit.

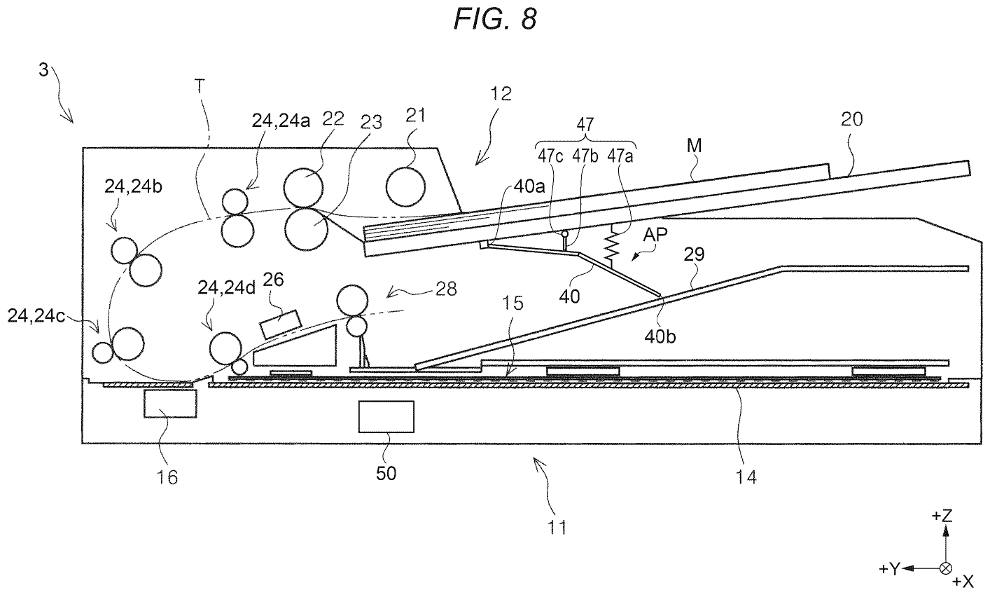

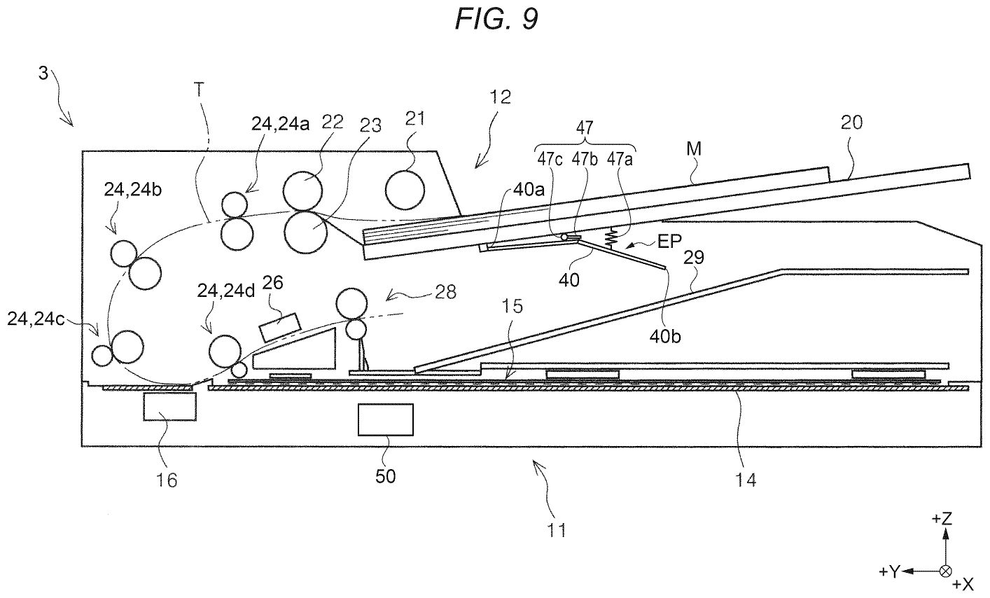

FIGS. 8 and 9 show a schematic configuration of the scanner unit 3. The configuration of the scanner unit 3 shown in FIGS. 8 and 9 is the same as the configuration of the scanner unit 3 shown in FIGS. 2 and 3 except for the configuration of the document presser bar drive mechanism 45. The scanner unit 3 shown in FIGS. 8 and 9 includes a lever drive mechanism 47 instead of the document presser bar drive mechanism 45. The lever drive mechanism 47 corresponds to an example of the switching mechanism.

FIG. 8 shows the document presser bar 40 in the actuation position AP. The document presser bar 40 is configured to be switchable between the actuation position AP and the evacuation position EP by driving of the lever drive mechanism 47. The support end portion 40a of the document presser bar 40 is supported by a surface of the document feeding tray 20 in the −Z direction or a side surface of the scanner unit 3. The actuation end portion 40b of the document presser bar 40 contacts the document M placed on the document ejection tray 29 when the document presser bar 40 is in the actuation position AP. The document presser bar 40 brakes the document M transported to the document ejection tray 29.

The lever drive mechanism 47 switches the position of the document presser bar 40. The lever drive mechanism 47 is disposed in a position in the +Z direction of the document presser bar 40. The lever drive mechanism 47 includes a support spring 47a, a pivot lever 47b, a pivot lever support shaft 47c, and a lever pivoting motor. The lever pivoting motor is provided instead of the cam drive motor 45c shown in FIG. 4. The lever pivoting motor is not shown.

The support spring 47a displaceably supports the document presser bar 40. The support spring 47a is supported by the surface in the −Z direction of the document feeding tray 20. The support spring 47a applies tension in the +Z direction to the document presser bar 40. The support spring 47a pulls up the actuation end portion 40b to a position where the actuation end portion 40b of the document presser bar 40 does not contact the document M placed on the document ejection tray 29. The support spring 47a switches the position of the document presser bar 40 to the evacuation position EP by tension.

The pivot lever 47b pivots by the driving force of the lever pivoting motor. The pivot lever 47b pivots to switch the position of the document presser bar 40 to the actuation position AP or the evacuation position EP. The pivot lever 47b shown in FIG. 8 pivots by the driving force of the lever pivoting motor and contacts the document presser bar 40. The pivot lever 47b rotates the document presser bar 40 in the −Z direction to switch the position of the document presser bar 40 to the actuation position AP. The pivot lever 47b applies stress against the tension applied by the support spring 47a to the document presser bar 40. The pivot lever 47b rotates the document presser bar 40 in the −Z direction by applying stress. The document presser bar 40 shown in FIG. 8 is switched to the actuation position AP by the stress applied to the document presser bar 40 by the pivot lever 47b.

The pivot lever support shaft 47c pivotably supports the pivot lever 47b. The pivot lever support shaft 47c is supported by the surface in the −Z direction of the document feeding tray 20 or the side surface of the scanner unit 3. The pivot lever 47b pivots about the pivot lever support shaft 47c.

FIG. 9 shows the document presser bar 40 in the evacuation position EP. When the document presser bar 40 is in the evacuation position EP, as shown in FIG. 9, the actuation end portion 40b of the document presser bar 40 is located in a position without contact with the document M on the document ejection tray 29. The document presser bar 40 does not brake the document M in the evacuation position EP. When the document presser bar 40 is in the evacuation position EP, the actuation end portion 40b of the document presser bar 40 may be located in a position where the portion contacts the document M curled in a predetermined amount or more. When the document presser bar 40 is in the evacuation position EP, the bar contacts the document M curled in the predetermined amount or more. The document presser bar 40 functions as a member suppressing curling of the document M.

When the document presser bar 40 is in the evacuation position EP, the pivot lever 47b pivots to a non-operation position where no stress is applied to the document presser bar 40. The pivot lever 47b in the non-operation position does not contact the document presser bar 40 as an example. When the pivot lever 47b pivots to the non-operation position, the support spring 47a pulls up the document presser bar 40 in the +Z direction by tension. The document presser bar 40 is switched to the evacuation position EP by the tension of the support spring 47a.

The pivot lever 47b is adjusted in pivot angle to change the position of the actuation end portion 40b of the document presser bar 40. The document presser bar control unit 75 adjusts the pivot angle of the pivot lever 47b to switch the position of the document presser bar 40.

### Third Embodiment

A third embodiment shows an example of the configuration of the document presser bar 40. The contact stress applied to the document M can be adjusted by the configuration of the document presser bar 40. The position of the document presser bar 40 may be adjusted by the configuration and operation of the document presser bar 40.

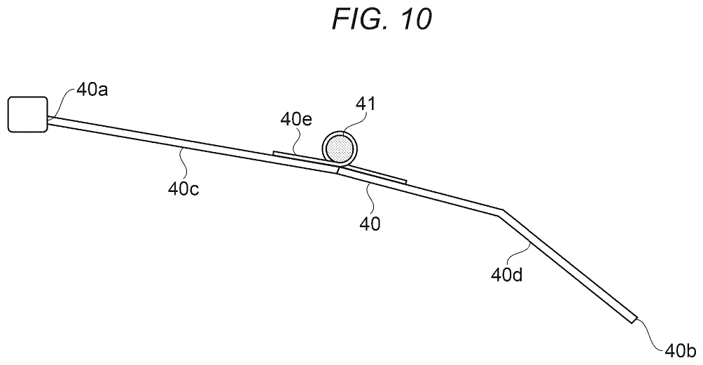

FIG. 10 shows an example of the configuration of the document presser bar 40. The support end portion 40a of the document presser bar 40 is supported by the surface of the document feeding tray 20 in the −Z direction or the side surface of the scanner unit 3. The actuation end portion 40b is configured to be contactable with the document M placed on the document ejection tray 29. The document presser bar 40 illustrated in FIG. 10 includes a base material 40c, an actuation member 40d, and a joint spring 40e.

The base material 40c includes the support end portion 40a of the document presser bar 40. The base material 40c is supported by the surface in the −Z direction of the document feeding tray 20 or the side surface of the scanner unit 3. The base material 40c corresponds to an example of a first braking portion.

The actuation member 40d includes the actuation end portion 40b of the document presser bar 40. The actuation member 40d can contact the document M placed on the document ejection tray 29. The actuation member 40d shown in FIG. 10 has a bent portion, but is not limited thereto. The actuation member 40d may not have the bent portion. The actuation member 40d corresponds to an example of a second braking portion.

The joint spring 40e joins the base material 40c and the actuation member 40d. The joint spring 40e includes a torsional spring as an example. The joint spring 40e applies tension to the base material 40c and the actuation member 40d to support the material and the member. The joint spring 40e pivotably supports the actuation member 40d with respect to the base material 40c. The joint spring 40e pivotably supports the actuation member 40d, and thereby, the contact stress when the actuation end portion 40b contacts the document M may be adjusted. The joint spring 40e may switch the position of the document presser bar 40 to an intermediate position different from the actuation position AP and the evacuation position EP by pivotably supporting the actuation member 40d. The joint spring 40e is supported by a joint spring support shaft 41. The joint spring 40e corresponds to an example of a support member.

The joint spring support shaft 41 supports the joint spring 40e. The joint spring support shaft 41 can apply rotational stress to the joint spring 40e. The joint spring support shaft 41 applies rotational stress to the joint spring 40e, and thereby, the position of the actuation member 40d with respect to the base material 40c is changed. When the position of the actuation member 40d varies, the stress applied to the document M by the actuation end portion 40b varies. When the position of the actuation member 40d is changed, the position of the actuation end portion 40b with respect to the document M changes, and the position of the document presser bar 40 is displaced. The stress applied to the document M by the document presser bar 40 or the position of the document presser bar 40 is adjusted.

The document presser bar 40 preferably includes the base material 40c, the actuation member 40d, and the joint spring 40e that pivotably supports the actuation member 40d with respect to the base material 40c.

The stress applied to the document M by the document presser bar 40 can be adjusted. Further, the position of the document presser bar 40 can be adjusted.

### Fourth Embodiment

A fourth embodiment shows the printer unit 2 including a medium presser bar 140. The printer unit 2 forms a part of the multifunction peripheral 1, but is not limited thereto. The printer unit 2 may be configured as a single unit.

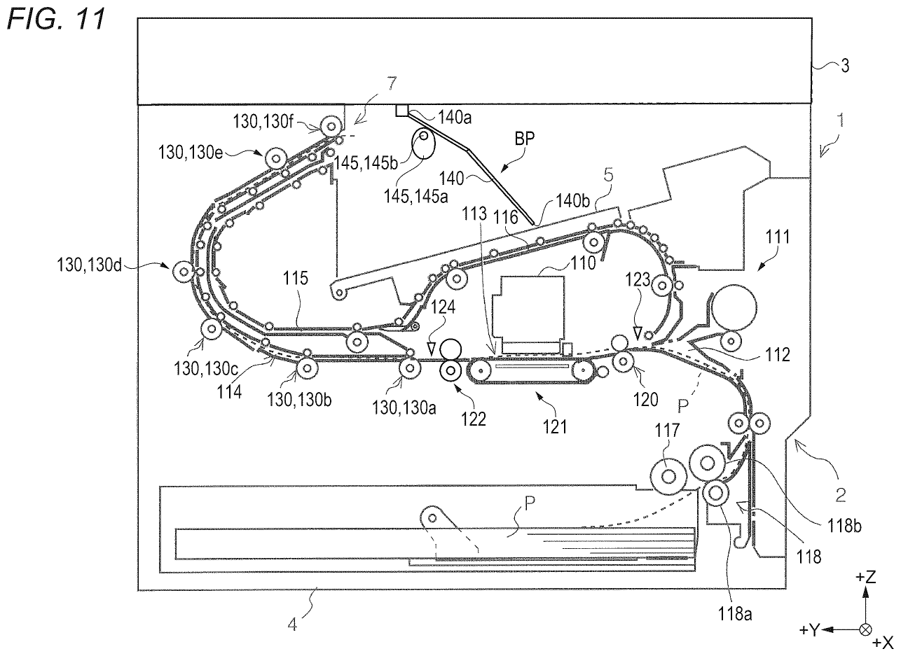

FIG. 11 shows a schematic configuration of the printer unit 2. FIG. 11 shows an internal configuration of the printer unit 2 contained in the multifunction peripheral 1. FIG. 11 shows the print head 110, a transport path 111, and the medium presser bar 140. The printer unit 2 corresponds to an example of a liquid ejection apparatus.

The print head 110 ejects ink onto the print medium P based on print data input from an external apparatus or the like. The print head 110 prints an image or the like on the print medium P by ejecting ink onto the print medium P. The print head 110 is, for example, an ink jet head that ejects ink onto the print medium P. The ink corresponds to an example of a liquid. The print head 110 corresponds to an example of a liquid ejection unit.

The transport path 111 is a path for transporting the print medium P supplied from the medium container cassette 4 toward the medium placement portion 5. The transport path 111 includes a feeding path 112, a straight path 113, a face-down path 114, a switchback path 115, and an inversion path 116.

The feeding path 112 is a path for transporting the print medium P from the medium container cassette 4 toward the print head 110. The print medium P picked up from the medium container cassette 4 is transported toward the print head 110 along the feeding path 112. A feeding roller 117 and a separating roller pair 118 are arranged along the feeding path 112.

The feeding roller 117 picks up the print medium P placed on the medium container cassette 4. The feeding roller 117 transports the print medium P placed on a position in the +Z direction among a plurality of print media P placed in the medium container cassette 4 to the feeding path 112. The feeding roller 117 is rotationally driven by a medium transport mechanism 160, which will be described later.

When a plurality of print media P are transported by the feeding roller 117, the separating roller pair 118 separates the print media P in one sheet. The separating roller pair 118 transports the separated one print medium P toward the print head 110. The separating roller pair 118 includes a drive roller 118a and a driven roller 118b.

The drive roller 118a transports the print medium P toward the print head 110. The drive roller 118a is disposed in a position with the feeding path 112 in between with respect to the driven roller 118b. The drive roller 118a is rotationally driven by the medium transport mechanism 160.

The driven roller 118b contacts the drive roller 118a via the print medium P to form a nip. The print medium P is sandwiched in the nip between the drive roller 118a and the driven roller 118b. The driven roller 118b rotates to follow the rotational driving of the drive roller 118a.

The straight path 113 is a path in which the print medium P is printed by the print head 110. The straight path 113 is coupled to the feeding path 112. The straight path 113 is disposed in a position in the −Z direction of the print head 110. The print head 110, a first transport roller pair 120, a belt transport unit 121, a second transport roller pair 122, a first medium sensor 123, and a second medium sensor 124 are arranged along the straight path 113.

The print head 110 is disposed in a position in the +Z direction of the straight path 113. The print head 110 prints the print medium P transported in the +Y direction along the straight path 113. The print head 110 is disposed in a position facing the belt transport unit 121 with the straight path 113 in between.

The first transport roller pair 120 transports the print medium P transported in the feeding path 112 toward the belt transport unit 121. The first transport roller pair 120 is disposed in a position in the −Y direction of the print head 110 and the belt transport unit 121.

The belt transport unit 121 supports the print medium P to be printed by the print head 110 and transports the print medium P in the +Y direction. The belt transport unit 121 is disposed in a position in the −Z direction of the straight path 113. The belt transport unit 121 is disposed in a position facing the print head 110 via the straight path 113.

The second transport roller pair 122 transports the print medium P printed by the print head 110 to the face-down path 114 or the switchback path 115. The second transport roller pair 122 is disposed in a position in the +Y direction of the print head 110 and the belt transport unit 121.

The first medium sensor 123 detects presence or absence of the print medium P transported toward the first transport roller pair 120. The first medium sensor 123 is disposed in a position in the −Y direction of the first transport roller pair 120. The first medium sensor 123 includes an optical sensor, a mechanical sensor, or the like.

The second medium sensor 124 detects presence or absence of the print medium P transported by the second transport roller pair 122. The second medium sensor 124 is disposed in a position in the +Y direction of the second transport roller pair 122. The second medium sensor 124 includes an optical sensor, a mechanical sensor, or the like.

The face-down 114 path is a path for transporting the print medium P printed by the print head 110 to the eject portion 7. The face-down path 114 is coupled to the straight path 113. The face-down path 114 is a path in which the printed surface of the print medium P printed by the print head 110 is directed to the −Z direction and ejected from the eject portion 7 in. A plurality of medium transport roller pairs 130 are arranged in the face-down path 114.

The plurality of medium transport roller pairs 130 transport the print medium P along the face-down path 114. The plurality of medium transport roller pairs 130 include a first medium transport roller pair 130a, a second medium transport roller pair 130b, a third medium transport roller pair 130c, a fourth medium transport roller pair 130d, a fifth medium transport roller pair 130e, and a sixth medium transport roller pair 130f. The first medium transport roller pair 130a, the second medium transport roller pair 130b, the third medium transport roller pair 130c, the fourth medium transport roller pair 130d, the fifth medium transport roller pair 130e, and the sixth medium transport roller pair 130f are arranged along the face-down path 114 sequentially from the position in the +Y direction of the second transport roller pair 122. The number of the plurality of medium transport roller pairs 130 is not limited to six. The number of medium transport roller pairs 130 is appropriately set.

The switchback path 115 is a path used when printing is performed on both sides of the print medium P using the print head 110. The switchback path 115 is used to reverse the transport direction of the print medium P. The switchback path 115 is coupled to the straight path 113 in a position in the +Y direction of the print head 110 and the belt transport unit 121. The straight path 113 is branched into the face-down path 114 and the switchback path 115.

The inversion path 116 is a path for inverting the front and back of the print medium P. The inversion path 116 is used when printing is performed on both sides of the print medium P using the print head 110. The inversion path 116 is coupled to the switchback path 115 and the straight path 113. The print medium P transported along the inversion path 116 is transported into the straight path 113 in a position in the −Y direction of the first transport roller pair 120 and the first medium sensor 123. The switchback path 115 and the inversion path 116 are used, and thereby, the print head 110 can eject ink to the front surface and the back surface of the print medium P. The printer unit 2 can perform double-side printing on the print medium P. The front surface corresponds to an example of a first surface. The back surface corresponds to an example of a second surface.

The medium presser bar 140 brakes the document M transported to the medium placement portion 5. The medium presser bar 140 contacts the print medium P transported to the medium placement portion 5. The medium presser bar 140 reduces the transport speed of the print medium P by contacting the print medium P. The transport speed of the print medium P varies depending on the type, state, and the like of the print medium P. When the transport speed of the print medium P varies, the placement position of the print medium P on the medium placement portion 5 varies. The medium presser bar 140 can reduce variations in the placement position of the print medium P placed on the medium placement portion 5 by decelerating the print medium P.

The medium presser bar 140 is formed using a metal material, a resin material, or the like. The medium presser bar 140 is preferably formed using an elastic material. The medium presser bar 140 shown in FIG. 11 has a bent portion, but is not limited thereto. The medium presser bar 140 may be formed of a flat plate member, a curved member, or the like. The configuration of the medium presser bar 140 is not limited as long as the bar can brake the print medium P transported to the medium placement portion 5. The medium presser bar 140 corresponds to an example of the braking member. The medium presser bar 140 includes a bar support end portion 140a and a bar actuation end portion 140b.

The bar support end portion 140a is supported by the scanner unit 3 or the printer unit 2. The bar support end portion 140a may displaceably support the medium presser bar 140. The bar support end portion 140a is supported by the surface in the −Z direction of the scanner unit 3 or the side surface in the +X direction or the −X direction of the printer unit 2.

The bar actuation end portion 140b contacts the print medium P on the medium placement portion 5. The bar actuation end portion 140b is a displaceable free end. The bar actuation end portion 140b may be rounded. The bar actuation end portion 140b may be provided with a member that applies a load to the print medium P or the like.

The medium presser bar drive mechanism 145 switches the position of the medium presser bar 140. The medium presser bar drive mechanism 145 corresponds to an example of the switching mechanism. The medium presser bar drive mechanism 145 has a medium presser bar drive cam 145a, a medium presser bar drive cam shaft 145b, and a bar drive motor 145c. The bar drive motor 145c will be described later.

The medium presser bar drive cam 145a rotates to change the position in contact with the medium presser bar 140. The medium presser bar drive cam 145a may rotate to be separated from the medium presser bar 140. The medium presser bar drive cam 145a rotates, and thereby, the medium presser bar 140 is displaced to a braking position BP or the standby position SP. The medium presser bar drive cam 145a is driven under the control of a medium presser bar control unit 175, which will be described later. The medium presser bar drive cam 145a corresponds to an example of the cam.

The medium presser bar drive cam shaft 145b rotatably supports the medium presser bar drive cam 145a. The medium presser bar drive cam shaft 145b is supported by the side surface of the printer unit 2 or the surface in the −Z direction of the scanner unit 3. The medium presser bar drive cam 145a rotates about the medium presser bar drive cam shaft 145b.

FIG. 11 shows the medium presser bar 140 in the braking position BP. When the medium presser bar 140 is in the braking position BP, the bar actuation end portion 140b of the medium presser bar 140 is located in a position where the portion can contact the print medium P on the medium placement portion 5. The medium presser bar 140 can brake the print medium P in the braking position BP. The braking position BP is a position for braking the print medium P. The braking position BP corresponds to an example of a first position.

The medium presser bar 140 shown in FIG. 11 takes the braking position BP by its own weight and the contact position with the medium presser bar drive cam 145a. In FIG. 11, the medium presser bar drive cam 145a contacts the medium presser bar 140, but is not limited thereto. The medium presser bar drive cam 145a may be separated from the medium presser bar 140. The medium presser bar 140 is displaced into the braking position BP by its own weight.

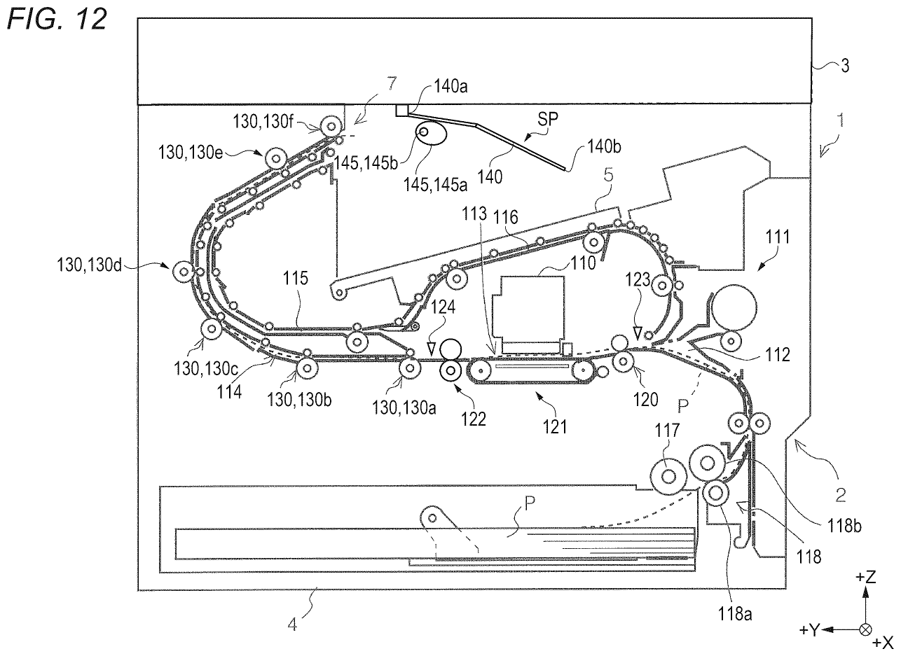

FIG. 12 shows a schematic configuration of the printer unit 2. FIG. 12 shows an internal configuration of the printer unit 2 contained in the multifunction peripheral 1. FIG. 12 shows the medium presser bar 140 in a standby position SP. FIG. 12 has the same configuration as the printer unit 2 shown in FIG. 11 except for the position of the medium presser bar 140.

FIG. 12 shows the medium presser bar 140 in a standby position SP. When the medium presser bar 140 is in the standby position SP, the bar actuation end portion 140b of the medium presser bar 140 is located in a position without contact with the print medium P on the medium placement portion 5 as shown in FIG. 12. The medium presser bar 140 does not brake the print medium P in the standby position SP. The standby position SP is, for example, a position in which the print medium P is not braked. When the medium presser bar 140 is in the standby position SP, the bar actuation end portion 140b of the medium presser bar 140 may be located in a position where the portion contacts the print medium P curled in a predetermined amount or more. In the standby position SP, the medium presser bar 140 contacts the print medium P curled in the predetermined amount or more. The medium presser bar 140 functions as a member for suppressing curling of the print medium P. The standby position SP is a position different from the braking position BP. The standby position SP corresponds to an example of a second position.

The medium presser bar drive cam 145a shown in FIG. 12 contacts the medium presser bar 140 when the medium presser bar 140 is in the standby position SP. The medium presser bar drive cam 145a rotates to push up the medium presser bar 140. The medium presser bar 140 pivots about the bar support end portion 140a by the medium presser bar drive cam 145a, and is displaced to the standby position SP. The rotation angle and the like of the medium presser bar drive cam 145a are appropriately set.

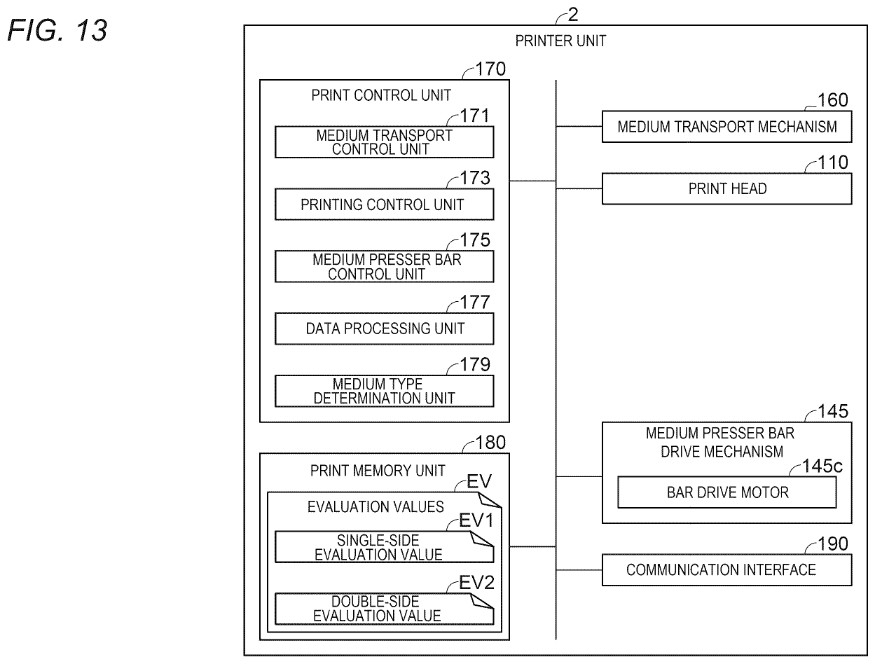

FIG. 13 shows a block configuration of the printer unit 2. The printer unit 2 has the print head 110, the medium presser bar drive mechanism 145, the medium transport mechanism 160, a print control unit 170, a print memory unit 180, and a communication interface 190.

The print head 110 ejects ink onto the print medium P based on print data input from an external apparatus or the like. The print head 110 prints the print medium P by ejecting ink onto the print medium P under control of the print control unit 170.

The medium presser bar drive mechanism 145 drives the medium presser bar 140. The medium presser bar drive mechanism 145 has the bar drive motor 145c and a drive transmission mechanism (not shown) in addition to the medium presser bar drive cam 145a. The bar drive motor 145c generates a driving force. The drive transmission mechanism transmits the driving force to the medium presser bar drive cam 145a. The medium presser bar drive cam 145a is rotated by the transmitted driving force. The bar drive motor 145c corresponds to an example of the drive source.

The medium transport mechanism 160 drives the feeding roller 117, the separating roller pair 118, the first transport roller pair 120, the belt transport unit 121, the second transport roller pair 122, and the plurality of medium transport roller pairs 130. The medium transport mechanism 160 includes a drive source that generates a driving force. The medium transport mechanism 160 transmits the driving force generated by the drive source to the medium transport roller pair 130 and the like. The medium transport mechanism 160 transmits the driving force to drive the medium transport roller pair 130 and the like. The medium transport mechanism 160 transports the print medium P placed on the medium container cassette 4 toward the medium placement portion 5 by driving the medium transport roller pair 130 and the like. The medium transport mechanism 160 corresponds to an example of the transport unit.

The print control unit 170 is a controller circuit that controls the printer unit 2. The print control unit 170 is, for example, a processor having a CPU. The print control unit 170 includes one or more processors. The print control unit 170 operates as a functional unit by executing the printing control program. The print control unit 170 functions as a medium transport control unit 171, a printing control unit 173, the medium presser bar control unit 175, and a data processing unit 177. The print control unit 170 may function as a medium type determination unit 179. The print control unit 170 may function as a functional unit other than the medium transport control unit 171, the printing control unit 173, the medium presser bar control unit 175, and the data processing unit 177.

The medium transport control unit 171 controls transport of the print medium P. The medium transport control unit 171 controls the medium transport mechanism 160 to transport the print medium P along the transport path 111. The medium transport control unit 171 controls a timing to start transport of the print medium P, a transport speed of the print medium P, a transport path of the print medium P, and the like.

The printing control unit 173 controls printing on the print medium P by the print head 110. The printing control unit 173 controls the print head 110 to cause the print head 110 to print the print medium P. The printing control unit 173 controls the print timing of the print head 110, the amount of ink when the print head 110 ejects ink, the ejection position of ink, and the like.

The medium presser bar control unit 175 controls the position of the medium presser bar 140. The medium presser bar control unit 175 controls the medium presser bar drive mechanism 145 to drive the medium presser bar drive cam 145a. The medium presser bar control unit 175 displaces the medium presser bar 140 to the braking position BP or the standby position SP by driving the medium presser bar drive cam 145a.

The medium presser bar control unit 175 acquires print condition data such as a print duty value from the data processing unit 177. The medium presser bar control unit 175 determines to set the position of the medium presser bar 140 to the braking position BP or the standby position SP based on the acquired print condition data. The medium presser bar drive mechanism 145 displaces the medium presser bar 140 to the determined position under control of the medium presser bar control unit 175. The medium presser bar drive mechanism 145 sets the medium presser bar 140 to the braking position BP or the standby position SP.

As an example, the medium presser bar control unit 175 determines to set the position of the medium presser bar 140 to the braking position BP or the standby position SP using an evaluation value EV. The medium presser bar control unit 175 reads the evaluation value EV from the print memory unit 180. The medium presser bar control unit 175 determines the position of the medium presser bar 140 by comparing the print condition data with the evaluation value EV.

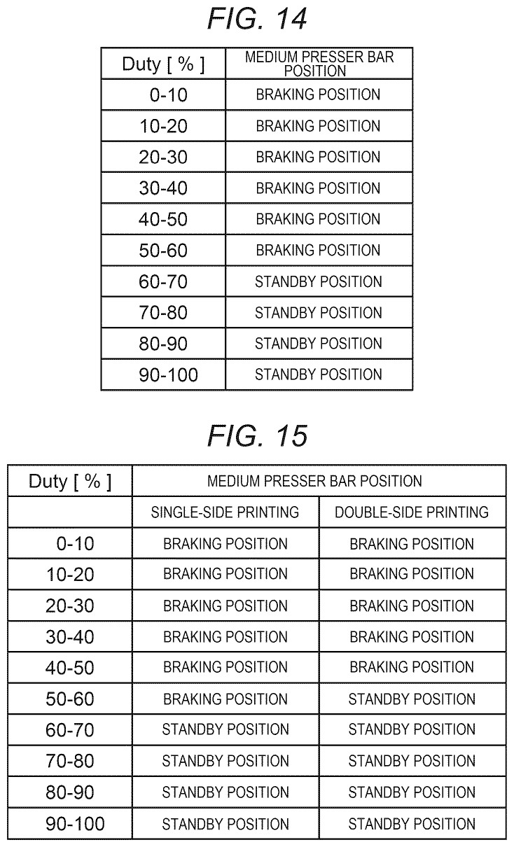

FIG. 14 shows a relationship between the print duty value and the medium presser bar position. FIG. 14 shows the relationship between the print duty value and the medium presser bar position when the type of the print medium P is standard paper and single-side printing is performed. The standard paper indicates a paper having a predetermined paper thickness. The standard paper corresponds to an example of a first type. Duty shown in FIG. 14 indicates the print duty value as an example of the print condition data. The medium presser bar position indicates the position of the medium presser bar 140. The relationship between the print duty value and the medium presser bar position shown in FIG. 14 is determined in advance. The evaluation value EV is determined from the relationship between the print duty value and the medium presser bar position shown in FIG. 14, and is stored in the print memory unit 180. The evaluation value EV determined based on FIG. 14 is, for example, a single-side evaluation value EV1. The single-side evaluation value EV1 corresponds to an example of an ejection amount threshold.

The print duty value is obtained from a dot number of the ink ejected onto the print medium P. The print duty value is calculated using a dot number D of the ink ejected onto the print medium P based on the print data and the maximum dot number Dmax of the ink that can be ejected onto the print medium P. The print duty value is calculated by the following equation (1).

$$Print duty value ( \% ) = D / D max \times 100 \qquad ( 1 )$$

In FIG. 14, in a range of the print duty value less than 60%, the medium presser bar position is the braking position BP. In a range of the print duty value equal to or more than 60%, the medium presser bar position is the standby position SP. From FIG. 14, the print duty value of 60% is determined as the evaluation value EV and stored in the print memory unit 180. The medium presser bar control unit 175 determines the position of the medium presser bar 140 using the evaluation value EV stored in the print memory unit 180 and the print duty value calculated by the data processing unit 177.

The data processing unit 177 shown in FIG. 13 acquires the print condition data. The print condition data corresponds to an example of an index related to the state of the medium. As an example, the data processing unit 177 calculates the print duty value as the print condition data. When the printer unit 2 prints the print medium P, the print control unit 170 receives the print data from an external apparatus or the like. The data processing unit 177 acquires and analyzes the print data. The data processing unit 177 calculates the dot number D of the ink to be ejected onto the print medium P. The data processing unit 177 divides the calculated dot number D of the ink by the maximum dot number Dmax of the ink that can be ejected onto the print medium P to calculate the print duty value. The maximum dot number Dmax of ink that can be ejected onto the print medium P is stored in advance. The print duty value corresponds to an example of a liquid ejection amount. The data processing unit 177 acquires the print condition data by calculating the print duty value. The data processing unit 177 corresponds to an example of the acquisition unit.

The data processing unit 177 transmits the print duty value to the medium presser bar control unit 175. The medium presser bar control unit 175 receives the print duty value from the data processing unit 177. The medium presser bar control unit 175 acquires the evaluation value EV from the print memory unit 180. The medium presser bar control unit 175 compares the print duty value received from the data processing unit 177 with the evaluation value EV, and determines the position of the medium presser bar 140.

As an example, the medium presser bar control unit 175 acquires an evaluation value EV with a print duty value of 60% from the print memory unit 180. When the print duty value received from the data processing unit 177 is less than 60%, the medium presser bar control unit 175 determines the position of the medium presser bar 140 to be the braking position BP. The medium presser bar drive mechanism 145 sets the position of the medium presser bar 140 to the braking position BP under control of the medium presser bar control unit 175. When the print duty value received from the data processing unit 177 is equal to or more than 60%, the medium presser bar control unit 175 determines the position of the medium presser bar 140 to be the standby position SP. The medium presser bar drive mechanism 145 sets the position of the medium presser bar 140 to the standby position SP under control of the medium presser bar control unit 175.

The print memory unit 180 stores various types of information. The print memory unit 180 stores a printing control program executed by the print control unit 170. The print memory unit 180 stores a plurality of evaluation values EV. The print memory unit 180 may store print data, read data transmitted from the scanner unit 3, and the like. The print memory unit 180 includes a semiconductor memory such as a ROM and a RAM.

The plurality of evaluation values EV include the single-side evaluation value EV1 and a double-side evaluation value EV2. The single-side evaluation value EV1 is used when the printer unit 2 performs single-side printing for printing the front surface or the back surface of the print medium P. The double-side evaluation value EV2 is used when the printer unit 2 performs double-side printing for printing the front surface and the back surface of the print medium P. The plurality of evaluation values EV may include a paper type evaluation value for each type of the print medium P. The plurality of evaluation values EV include, for example, a thin paper evaluation value and a thick paper evaluation value. The thin paper evaluation value is an evaluation value EV used when thin paper having a paper thickness smaller than the standard paper is printed. The thick paper evaluation value is an evaluation value EV used when thick paper having a paper thickness larger than the standard paper is printed.

FIG. 15 shows a relationship between the print duty value and the medium presser bar position. Duty and the medium presser bar position shown in FIG. 15 are the same as the Duty and the medium presser bar position shown in FIG. 14. The relationship between the print duty value and the medium presser bar position shown in FIG. 15 is determined in advance. FIG. 15 shows the relationship between the print duty value and the medium presser bar position when the printer unit 2 performs single-side printing on the print medium P. FIG. 15 shows the relationship between the print duty value and the medium presser bar position when the printer unit 2 performs double-side printing on the print medium P. The single-side evaluation value EV1 and the double-side evaluation value EV2 are determined from the relationship between the print duty value and the medium presser bar position shown in FIG. 15, and stored in the print memory unit 180.

As shown in FIG. 15, when the printer unit 2 performs single-side printing, the medium presser bar position is the braking position BP in a range of the print duty value less than 60%. In a range of the print duty value equal to or more than 60%, the medium presser bar position is the standby position SP. From FIG. 15, the print duty value of 60% is determined as the single-side evaluation value EV1 and stored in the print memory unit 180. When the printer unit 2 performs single-side printing, the medium presser bar control unit 175 determines the position of the medium presser bar 140 using the single-side evaluation value EV1 stored in the print memory unit 180 and the print duty value calculated by the data processing unit 177. When the print duty value calculated by the data processing unit 177 is less than 60%, the medium presser bar control unit 175 determines the position of the medium presser bar 140 to be the braking position BP. The medium presser bar drive mechanism 145 sets the position of the medium presser bar 140 to the braking position BP under control of the medium presser bar control unit 175. When the print duty value calculated by the data processing unit 177 is 60% or more, the medium presser bar control unit 175 determines the position of the medium presser bar 140 to be the standby position SP. The medium presser bar drive mechanism 145 sets the position of the medium presser bar 140 to the standby position SP under control of the medium presser bar control unit 175.

As shown in FIG. 15, when the printer unit 2 performs double-side printing, the medium presser bar position is the braking position BP when the print duty value is less than 50%. When the print duty value is 50% or more, the medium presser bar position is the standby position SP. From FIG. 15, the print duty value of 50% is determined as the double-side evaluation value EV2 and stored in the print memory unit 180. The double-side evaluation value EV2 corresponds to an example of a double-side ejection amount threshold.

The medium presser bar control unit 175 determines the position of the medium presser bar 140 using the double-side evaluation value EV2 stored in the print memory unit 180 and the double-side print duty value calculated by the data processing unit 177. The double-side print duty value is a value calculated using the dot number of ink ejected on both sides of the print medium P when the printer unit 2 performs double-side printing. The double-side print duty value is a value obtained by dividing the dot number of the ink to be ejected onto both sides of the print medium P by the maximum dot number of the ink that can be ejected onto both sides of the print medium P. The double-side print duty value corresponds to an example of a double-side ejection amount of the liquid. When the double-side print duty value calculated by the data processing unit 177 is less than 50%, the medium presser bar control unit 175 determines the position of the medium presser bar 140 to be the braking position BP. The medium presser bar drive mechanism 145 sets the position of the medium presser bar 140 to the braking position BP under control of the medium presser bar control unit 175. When the double-side print duty value calculated by the data processing unit 177 is 50% or more, the medium presser bar control unit 175 determines the position of the medium presser bar 140 to be the standby position SP. The medium presser bar drive mechanism 145 sets the position of the medium presser bar 140 to the standby position SP under control of the medium presser bar control unit 175.

The single-side evaluation value EV1 and the double-side evaluation value EV2, which are determined based on the relationship between the print duty value and the medium presser bar position shown in FIG. 15, are different values. The amount of ink ejected onto the print medium P is different between single-side printing and double-side printing. When the amount of ink ejected onto the print medium P increases, the stiffness of the print medium P decreases. When the stiffness of the print medium P decreases, the chance that the print medium P is broken by the medium presser bar 140 increases. The print medium P on which double-side printing is performed is more likely to be broken by the medium presser bar 140 than the print medium P on which single-side printing is performed with the same print duty value. Therefore, the double-side evaluation value EV2 is preferably smaller than the single-side evaluation value EV1.

The medium type determination unit 179 shown in FIG. 13 determines the type of the print medium P. The type of the print medium P is classified by the thickness of the print medium P, the basis weight of the print medium P, the material of the print medium P, the size of the print medium P, and the like. The medium type determination unit 179 determines the type of the print medium P based on input data input to the operation panel 6 or a detection result of a paper thickness sensor or the like provided in the transport path 111. The medium type determination unit 179 transmits the type information of the determined print medium P to the medium presser bar control unit 175.

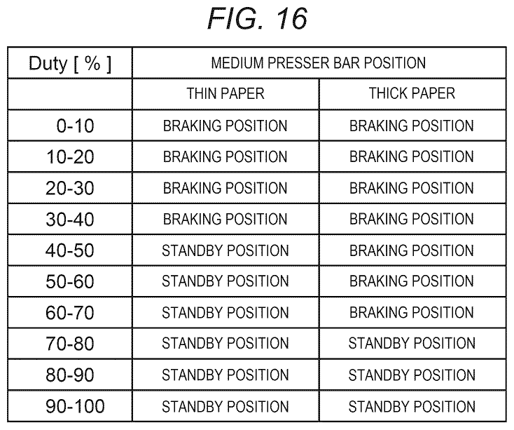

FIG. 16 shows a relationship between the print duty value and the medium presser bar position. Duty and the medium presser bar position shown in FIG. 16 are the same as Duty and the medium presser bar position shown in FIGS. 14 and 15. The relationship between the print duty value and the medium presser bar position shown in FIG. 16 is determined in advance. FIG. 16 shows the relationship between the print duty value and the medium presser bar position when the printer unit 2 performs printing using thin paper of a paper type thinner than the standard paper as the print medium P. The paper type thinner than the standard paper corresponds to an example of a second type. FIG. 16 shows the relationship between the print duty value and the medium presser bar position when the printer unit 2 performs printing using thick paper of a paper type thicker than the standard paper as the print medium P. The paper type thicker than the standard paper corresponds to an example of the second type. A thin paper evaluation value and a thick paper evaluation value are determined from the relationship between the print duty value and the medium presser bar position shown in FIG. 16, and stored in the print memory unit 180. The evaluation value EV includes the thin paper evaluation value and the thick paper evaluation value. The thin paper evaluation value and the thick paper evaluation value correspond to examples of the second ejection amount threshold.

As shown in FIG. 16, when the printer unit 2 prints thin paper, the medium presser bar position is the braking position BP in a range of the print duty value less than 40%. In a range of the print duty value equal to or more than 40%, the medium presser bar position is the standby position SP. From FIG. 16, the print duty value of 40% is determined as the thin paper evaluation value and stored in the print memory unit 180. The medium presser bar control unit 175 determines the position of the medium presser bar 140 using the thin paper evaluation value stored in the print memory unit 180 and the print duty value calculated by the data processing unit 177. When the print duty value calculated by the data processing unit 177 is less than 40%, the medium presser bar control unit 175 determines the position of the medium presser bar 140 to be the braking position BP. The medium presser bar drive mechanism 145 sets the position of the medium presser bar 140 to the braking position BP under control of the medium presser bar control unit 175. When the print duty value calculated by the data processing unit 177 is 40% or more, the medium presser bar control unit 175 determines the position of the medium presser bar 140 to be the standby position SP. The medium presser bar drive mechanism 145 sets the position of the medium presser bar 140 to the standby position SP under control of the medium presser bar control unit 175.

As shown in FIG. 16, when the printer unit 2 prints thick paper, the medium presser bar position is the braking position BP in a range of the print duty value less than 70%. In a range of the print duty value equal to or more than 70%, the medium presser bar position is the standby position SP. From FIG. 16, a print duty value of 70% is determined as a thick paper evaluation value and stored in the print memory unit 180.

The medium presser bar control unit 175 determines the position of the medium presser bar 140 using the thick paper evaluation value stored in the print memory unit 180 and the print duty value calculated by the data processing unit 177. When the print duty value calculated by the data processing unit 177 is less than 70%, the medium presser bar control unit 175 determines the position of the medium presser bar 140 to be the braking position BP. The medium presser bar drive mechanism 145 sets the position of the medium presser bar 140 to the braking position BP under control of the medium presser bar control unit 175. When the print duty value calculated by the data processing unit 177 is 70% or more, the medium presser bar control unit 175 determines the position of the medium presser bar 140 to be the standby position SP. The medium presser bar drive mechanism 145 sets the position of the medium presser bar 140 to the standby position SP under control of the medium presser bar control unit 175.

The thin paper evaluation value and the thick paper evaluation value determined based on the relationship between the print duty value and the medium presser bar position shown in FIG. 16 are different values. The thin paper and the thick paper have different stiffness. The thin paper has lower stiffness than the thick paper. When the print duty values are the same, thin paper is more likely to be broken by the medium presser bar 140 than thick paper. Therefore, the thin paper evaluation value is preferably smaller than the thick paper evaluation value.

The print memory unit 180 shown in FIG. 13 stores a plurality of evaluation values EV. The medium presser bar control unit 175 determines the position of the medium presser bar 140 using the evaluation value EV. The print memory unit 180 may store the tables shown in FIGS. 14, 15, and 16 as evaluation tables instead of the plurality of evaluation values EV. The medium presser bar control unit 175 determines the position of the medium presser bar 140 using the evaluation tables.

The communication interface 190 is an interface circuit for communication connection with the scanner unit 3 and an external apparatus. The communication interface 190 communicates with the scanner unit 3 and the like according to a predetermined communication protocol. The communication interface 190 includes a wired connector such as a USB connector. The communication interface 190 may include a wireless communication port that is communicably connected to an external apparatus. The communication interface 190 has various wireless ports such as a Wi-Fi communication port and a Bluetooth communication port, and is communicably connected to an external apparatus. The communication interface 190 receives read data as print data from the scanner unit 3. The communication interface 190 receives print data from an external apparatus. The communication interface 190 transmits a print result or the like to an external apparatus.

The printer unit 2 includes the medium container cassette 4 on which the print medium P is placed, the medium transport mechanism 160 transporting the print medium P placed on the medium container cassette 4, the print head 110 ejecting ink onto the print medium P based on the print data, the medium placement portion 5 on which the print medium P with the ink ejected by the print head 110 thereon is placed, the medium presser bar 140 braking the print medium P transported to the medium placement portion 5, the medium presser bar drive mechanism 145 switching the position of the medium presser bar 140, and the data processing unit 177 acquiring the print condition data. The medium presser bar drive mechanism 145 sets the medium presser bar 140 in the braking position BP for braking the print medium P or the standby position SP different from the braking position BP based on the print condition data acquired by the data processing unit 177.

The position of the medium presser bar 140 is changed based on the print condition data, and thereby, the printer unit 2 can reduce a transport failure such as breakage of the print medium P by the medium presser bar 140.

It is preferable that the data processing unit 177 acquires the print duty value of ejection onto the print medium P based on the print data as the print condition data.

The print duty value corresponds to the state of the print medium P. The printer unit 2 can set the medium presser bar 140 in the braking position BP or the standby position SP according to the state of the print medium P.

When the print duty value acquired by the data processing unit 177 is smaller than the predetermined single-side evaluation value EV1, the medium presser bar drive mechanism 145 sets the medium presser bar 140 in the braking position BP, and, when the print duty value acquired by the data processing unit 177 is larger than the single-side evaluation value EV1, the medium presser bar drive mechanism 145 sets the medium presser bar 140 in the standby position SP.

In the state in which the print medium P is easily broken by the medium presser bar 140, the printer unit 2 sets the bar in the standby position SP, and thereby, a transport failure of the print medium P may be reduced.

The print head 110 can eject the ink to the front surface and the back surface of the print medium P. When the print head 110 ejects the ink to the front surface and the back surface of the print medium P, the data processing unit 177 acquires the double-side print duty value of the ink ejected to the front surface and the back surface of the print medium P as the print condition data. When the double-side print duty value acquired by the data processing unit 177 is smaller than the double-side evaluation value EV2 different from the single-side evaluation value EV1, the medium presser bar drive mechanism 145 sets the medium presser bar 140 in the braking position BP. When the double-side print duty value acquired by the data processing unit 177 is larger than the double-side evaluation value EV2, the medium presser bar drive mechanism 145 sets the medium presser bar 140 in the standby position SP.

The printer unit 2 adjusts the position of the medium presser bar 140 with different evaluation values EV for single-side printing and double-side printing. The printer unit 2 can adjust the position of the medium presser bar 140 according to the state of the print medium P during double-side printing.

The data processing unit 177 acquires the type of the print medium P. When the type of the print medium P acquired by the data processing unit 177 is standard paper and the print duty value acquired by the data processing unit 177 is smaller than the single-side evaluation value EV1, the medium presser bar drive mechanism 145 sets the medium presser bar 140 in the braking position BP. When the type of the print medium P acquired by the data processing unit 177 is thin paper different from the standard paper and the print duty value acquired by the data processing unit 177 is smaller than the thin paper evaluation value different from the single-side evaluation value EV1, the medium presser bar drive mechanism 145 sets the medium presser bar 140 in the braking position BP.

The printer unit 2 can reduce a transport failure by adjusting the position of the medium presser bar 140 according to the type and state of the print medium P.

### Fifth Embodiment

A fifth embodiment shows the printer unit 2 including the medium presser bar 140. The printer unit 2 forms a part of the multifunction peripheral 1, but is not limited thereto. The printer unit 2 may be configured as a single unit.

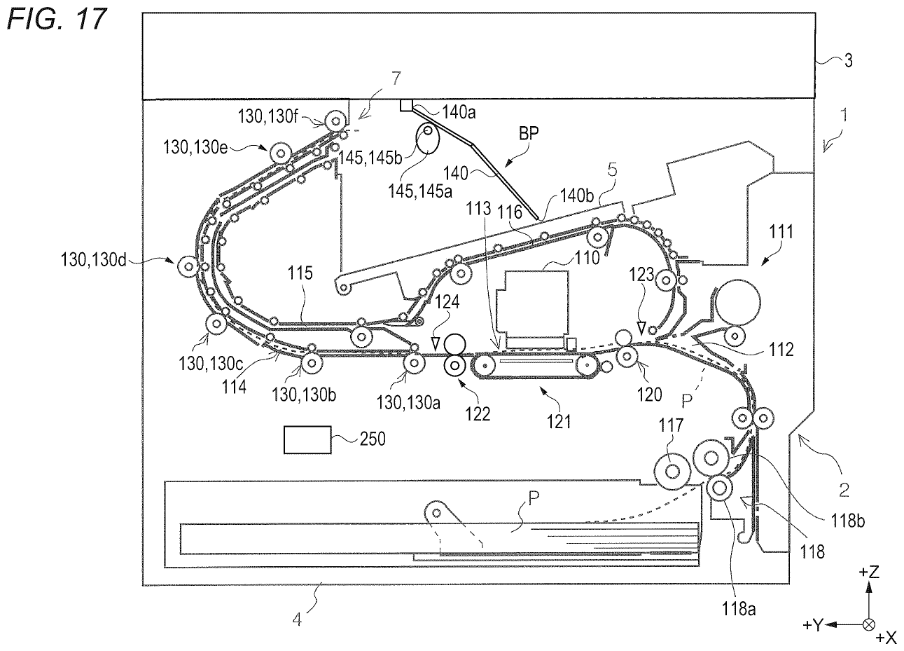

FIG. 17 shows a schematic configuration of the printer unit 2. FIG. 17 shows the schematic configuration of the printer unit 2 of the fifth embodiment. FIG. 17 shows an internal configuration of the printer unit 2 contained in the multifunction peripheral 1. FIG. 17 shows the print head 110, the transport path 111, and the medium presser bar 140. FIG. 17 shows the medium presser bar 140 in the braking position BP. The configuration of the printer unit 2 shown in FIG. 17 is the same as the configuration of the printer unit 2 shown in FIG. 11 except that an internal temperature and humidity sensor 250 is provided.

The internal temperature and humidity sensor 250 acquires environmental data of the print medium P placed on the medium container cassette 4 of the printer unit 2. The internal temperature and humidity sensor 250 measures at least one of the internal temperature and the internal humidity in the printer unit 2 as the environmental data. The internal temperature and the internal humidity are examples of data relating to the state of the print medium P placed on the medium container cassette 4. The environmental data corresponds to an example of the index. The environmental data including the internal temperature and the internal humidity corresponds to an example of the placement environment. The internal temperature and humidity sensor 250 is an example of the acquisition unit and corresponds to an example of a sensor. The internal temperature and humidity sensor 250 transmits at least one of the measured internal temperature and internal humidity to the print control unit 170.

The printer unit 2 may include an internal temperature sensor or an internal humidity sensor instead of the internal temperature and humidity sensor 250. The internal temperature sensor measures the internal temperature of the printer unit 2. The internal humidity sensor measures internal humidity of the printer unit 2.

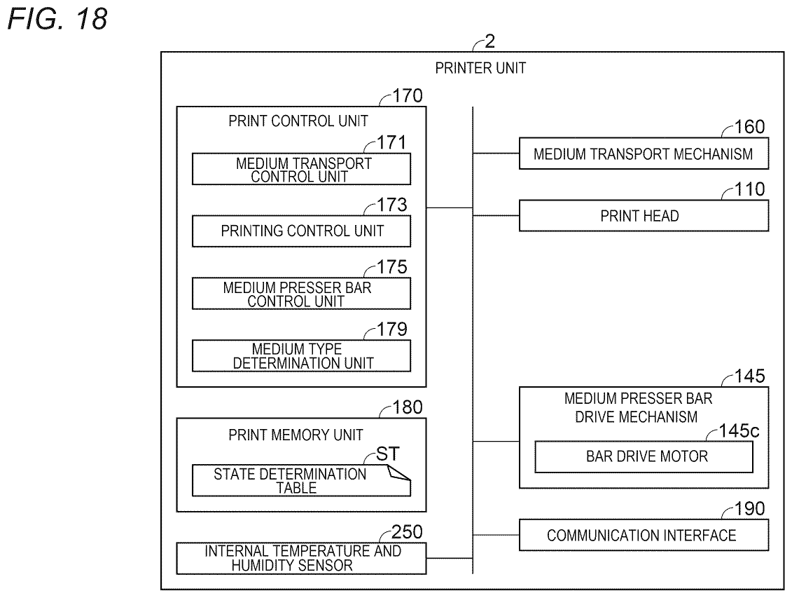

FIG. 18 shows a block configuration of the printer unit 2. The printer unit 2 includes the print head 110, the medium presser bar drive mechanism 145, the medium transport mechanism 160, the print control unit 170, the print memory unit 180, the communication interface 190, and the internal temperature and humidity sensor 250. The print head 110, the medium presser bar drive mechanism 145, the medium transport mechanism 160, and the communication interface 190 shown in FIG. 18 have the same configurations as the print head 110, the medium presser bar drive mechanism 145, the medium transport mechanism 160, and the communication interface 190 shown in FIG. 13.

The print control unit 170 functions as the medium transport control unit 171, the printing control unit 173, the medium presser bar control unit 175, and the medium type determination unit 179. The function of each functional unit is the same as the function of each functional unit shown in FIG. 13.

The print unit 180 stores a state determination table ST. The state determination table ST is used instead of the evaluation values EV shown in FIG. 13. The medium presser bar control unit 175 determines the position of the medium presser bar 140 using the state determination table ST.

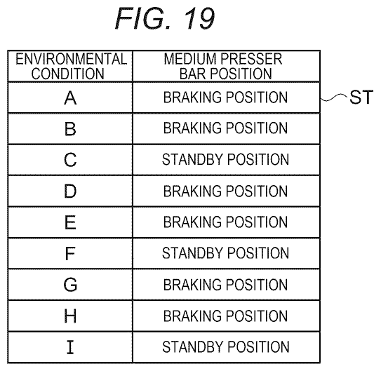

FIG. 19 shows an example of the state determination table ST. The state determination table ST shown in FIG. 19 shows a correspondence relationship between the environmental condition and the medium presser bar position. The medium presser bar position indicates the position of the medium presser bar 140. The environmental condition is divisionally shown in respective environmental ranges of a range A, a range B, a range C, a range D, a range E, a range F, a range G, a range H, and a range I. The environmental condition is divided based on the relationship between the environmental data and the environmental ranges shown in FIG. 6.

According to the state determination table ST, the environmental condition and the medium presser bar position is correlated. When the environmental condition is any one of the range A, the range B, the range D, the range E, the range G, and the range H, the medium presser bar position is set to the braking position BP. When the environmental conditions are the range C, the range F, and the range I, the medium presser bar position is set to the standby position SP.

When the environmental condition is, for example, the range C where the internal temperature is from 25° C. to 35° C. and the internal humidity is from 45% to 85%, the moisture content of the print medium P placed on the medium container cassette 4 increases. When the moisture content of the print medium P increases, the stiffness of the print medium P formed of paper decreases. When the stiffness of the print medium P decreases, wrinkles or the like may be produced in the print medium P due to contact with the medium presser bar 140. When the environmental condition is the range C, the medium presser bar control unit 175 controls the medium presser bar 140 to be in the standby position SP. When the medium presser bar 140 is in the standby position SP, the medium presser bar 140 does not contact the print medium P. The wrinkles or the like produced in the print medium P due to contact between the medium presser bar 140 and the print medium P can be prevented.

As an example, when the environmental condition is the range D where the internal temperature is 10° C. or more and less than 18° C. and the internal humidity is 35% or more and less than 45%, the moisture content of the print medium P placed on the medium container cassette 4 is low. When the moisture content of the print medium P is low, the stiffness of the print medium P formed of paper is maintained. When the stiffness of the print medium P is maintained, wrinkles or the like due to contact with the medium presser bar 140 are less likely to be produced in the print medium P. When the environmental condition is the range D, the medium presser bar control unit 175 controls the medium presser bar 140 to be in the braking position BP. When the medium presser bar 140 is in the braking position BP, the medium presser bar 140 and the print medium P contact. The medium presser bar 140 can brake the transported print medium P by contacting the print medium P.

The state determination table ST shown in FIG. 19 shows the relationship between the environmental condition and the medium presser bar position, but is not limited thereto. As an example, the state determination table ST may indicate a correspondence relationship between humidity and the medium presser bar position. In this case, the internal temperature and humidity sensor 250 measures the internal humidity. The medium presser bar control unit 175 determines the position of the medium presser bar 140 using the internal humidity and the state determination table ST indicating the correspondence relationship between the humidity and the medium presser bar position.

The medium presser bar control unit 175 determines to set the position of the medium presser bar 140 to the braking position BP or the standby position SP using the state determination table ST and at least one of the internal temperature and the internal humidity. The medium presser bar control unit 175 reads the state determination table ST from the print memory unit 180. The medium presser bar control unit 175 receives at least one of the internal temperature and the internal humidity from the internal temperature and humidity sensor 250. The medium presser bar control unit 175 determines the position of the medium presser bar 140 by comparing at least one of the internal temperature and the internal humidity with the state determination table ST. The medium presser bar drive mechanism 145 displaces the position of the medium presser bar 140 to the braking position BP or the standby position SP under control of the medium presser bar control unit 175.

The internal temperature and humidity sensor 250 preferably acquires the environmental data of the print medium P.

The internal temperature and humidity sensor 250 acquires the environmental data including the internal temperature and the internal humidity, and thereby, the printer unit 2 can adjust the position of the medium presser bar 140 based on the state of the print medium P.

What is claimed is:

1. A medium transport apparatus comprising:
a sheet feeding tray on which a medium is placed;
a transport unit transporting the medium placed on the sheet feeding tray;
a sheet ejection tray on which the medium transported by the transport unit is placed;
a braking member braking the medium transported to the sheet ejection tray;
a switching mechanism switching a position of the braking member; and
an acquisition unit acquiring an index related to a state of the medium, wherein
the switching mechanism sets the position of the braking member to a first position for braking the medium or a second position different from the first position based on the index acquired by the acquisition unit.

2. The medium transport apparatus according to claim 1, wherein
the acquisition unit acquires a placement environment of the medium as the index.

3. The medium transport apparatus according to claim 1, wherein
the switching mechanism includes a drive source and a cam that rotates by a driving force of the drive source.

4. The medium transport apparatus according to claim 1, wherein
the braking member includes a first braking portion, a second braking portion, and a support member that pivotably supports the second braking portion with respect to the first braking portion.

5. A liquid ejection apparatus comprising:
a sheet feeding tray on which a medium is placed;
a transport unit transporting the medium placed on the sheet feeding tray;
a liquid ejection unit ejecting a liquid onto the medium based on print data;
a sheet ejection tray on which the medium with the liquid ejected thereon by the liquid ejection unit is placed;
a braking member braking the medium transported to the sheet ejection tray;
a switching mechanism switching a position of the braking member; and
an acquisition unit acquiring an index related to a state of the medium,
wherein the switching mechanism sets the braking member in a first position for braking the medium or a second position different from the first position based on the index acquired by the acquisition unit.

6. The liquid ejection apparatus according to claim 5, wherein
the acquisition unit acquires an ejection amount of the liquid ejected onto the medium based on the print data as the index.

7. The liquid ejection apparatus according to claim 6, wherein
the switching mechanism sets the braking member in the first position when the ejection amount acquired by the acquisition unit is smaller than a predetermined ejection amount threshold, and sets the braking member in the second position when the ejection amount acquired by the acquisition unit is larger than the ejection amount threshold.

8. The liquid ejection apparatus according to claim 7, wherein
the liquid ejection unit is configured to eject the liquid onto a first surface and a second surface of the medium,
when the liquid ejection unit ejects the liquid onto the first surface and the second surface of the medium, the acquisition unit acquires a double-side ejection amount of the liquid ejected onto the first surface and the second surface of the medium as the index,
when the double-side ejection amount acquired by the acquisition unit is smaller than a double-side ejection amount threshold different from the ejection amount threshold, the switching mechanism sets the braking member in the first position, and
when the double-side ejection amount acquired by the acquisition unit is larger than the double-side ejection amount threshold, the switching mechanism sets the braking member in the second position.

9. The liquid ejection apparatus according to claim 6, wherein
the acquisition unit acquires a type of the medium,
when the type of the medium acquired by the acquisition unit is a first type and the ejection amount acquired by the acquisition unit is smaller than an ejection amount threshold, the switching mechanism sets the braking member in the first position, and
when the type of the medium acquired by the acquisition unit is a second type different from the first type and the ejection amount acquired by the acquisition unit is smaller than a second ejection amount threshold different from the ejection amount threshold, the switching mechanism sets the braking member in the first position.

10. The liquid ejection apparatus according to claim 5, wherein
the acquisition unit is a sensor that acquires a placement environment of the medium as the index.

11. A medium transport method comprising:
acquiring an index related to a state of a medium;
switching a position of a braking member that brakes the medium transported to a sheet ejection tray to a first position for braking the medium or a second position different from the first position based on the index; and
transporting the medium to the sheet ejection tray.
